(19) United States
(12) Patent Application Publication
(10) Pub. No.: US 2025/0371636 A1
(43) Pub. Date: Dec. 4, 2025

(54) Electronic Display Device with Improved User Interface for User-Selected Financial Strategy Based Update

(71) Applicant: Find Your Future, Inc., Dover, DE (US)

(72) Inventor: Kyle Winey, Dover, DE (US)

(73) Assignee: Find Your Future, Inc., Dover, DE (US)

(21) Appl. No.: 18/987,365

(22) Filed: Dec. 19, 2024

Related U.S. Application Data
(63) Continuation of application No. 18/731,147, filed on May 31, 2024, now abandoned.

(51) Int. Cl. G06Q 50/20; G06F 3/0482; G06Q 40/06

(52) U.S. Cl. CPC G06Q 50/2053; G06F 3/0482; G06Q 40/06

(57) ABSTRACT

Systems and methods including controlling an electronic device to display interactive elements corresponding to selectable optional financial reduction strategy buttons, and based on identifying a user selection of one of the interactive elements, displaying a user interface including the list of recommended educational institutions in a ranked order based on selectable a user selection corresponding to the optional financial reduction strategy and personalized school ranking information with a highest ranked educational institution at the top followed below by increasingly lower ranked educational institutions.

### BACKGROUND

### 1. Field

Embodiments relate generally to electronic devices, systems, and methods, and more particularly are directed to interactive electronic display devices for improved graphical user interfaces for personalized comparison and ranking of school options.

### 2. Related Art

Patent Literature 1 (U.S. Patent Application Publication No. 2014/0052663 A1, published Feb. 20, 2014).

### 3. Description of the Related Art

Various methods have been proposed for electronically evaluating and selecting schools based on user inputs via electronic devices. For example, Patent Literature 1 discloses matching the student to one or more schools based on a student's compatibility with the school's profile. Patent Literature 1, however, does not provide an interactive user experience that allows a user to make real time modifications to a student profile, much less, real time financial reduction strategy modifications.

Thus, a large burden for preparing the data for student compatibility remains even after Patent Literature 1. Due to the extremely laborious and lengthy protocols of such prior traditional manual and computer-assisted techniques, prior methods in this area have long suffered from the need of an efficient means of continuous real time collection of student profile information and providing real time assessment of student compatibility with colleges.

Thus, there is a need for improvements to graphical user interfaces and methods that enhance the user experience and provide greater accuracy of predictive student-school compatibility. There are other shortcomings of the methods in the related art, as discussed below.

The above information is presented as background information only to assist with an understanding of the disclosure. No determination has been made, and no assertion is made, as to whether any of the above might be applicable as prior art regarding the disclosure.

### SUMMARY

Aspects of the disclosure are to address at least the above-mentioned and below-mentioned problems and/or disadvantages and to provide at least the advantages described below. As discussed above, there is a need for improvements to graphical user interfaces and methods that enhance accuracy of predictive school compatibility.

As discussed similarly above, there is a need for networked electronic display devices with faster, more efficient display methods and customizable user interfaces.

Such methods and interfaces may complement or replace conventional methods for displaying information within interfaces. Such methods and interfaces reduce the cognitive burden on a user and produce a more efficient human-machine interface. For battery-operated devices, such methods and interfaces conserve power and increase the time between battery charges by providing a more efficient human-machine interface. The interfaces also provide an automated method (e.g., with relation to real time updates of student information) compared to the conventional technology.

According to various embodiments, the systems and methods allow users (e.g., students and parents) to better organize their data related to choosing a school. The calculation and presentation of digestible data is not something a human can reasonably do in a reasonable amount of time with, in this context, this type of data processing (e.g., millions of data points related to thousands of schools). Moreover, this approach centralizes important pieces of school related data and provides features that can be aggregated for a student (or parent) against all related schools and degrees. This approach creates value for users, while also discouraging the problematic spreadsheet hybrid human-machine data entry approach. According to various embodiments, a goal is to streamline data collection for choosing a school, and to provide summary reporting regarding the school's standards and admissions criteria (e.g., Big Data analysis). In addition, Patent Literature 1 is limited in regard to user interoperability, and in particular, does not provide a student/parent GUI.

According to various embodiments, the present disclosure provides features and components to: (i) increase user friendliness/ease of use of school compatibility-focused electronic devices, (ii) provide real time information (e.g., updates, notifications/alerts) via electronic devices, and (iii) enhance the accuracy of school compatibility information performed, at least in part, by electronic devices (e.g., a smartphone).

### SUMMARY OF PRODUCT/TECHNOLOGY DESCRIPTION

1. Categories. Analyzing three categories (fit, finance, and academics) to produce a ranked list of recommended schools/colleges.
2. Financial Strategies. Proposing recommended financial strategies to reduce student loans/overall school/college costs.
3. Admissions Strategies. Proposing recommendations on where to apply to college based upon a student's specific admission probability as assessed against the students' top colleges.
4. Excluded Colleges. Showing students other colleges that may be considered (could be recommended) but are not because of a student's specific survey response (i.e. an “Excluded Colleges” page).
5. Context/Implementation Details:

5A. Collecting User Input (e.g., Survey Data): Prompting a user to sequentially answer one or more questions about four main categories: (1) their high school academic credentials (e.g., SAT score), (2) their financial resources/criteria, (3) their college “fit” or subjective preferences criteria/objectives, and (4) their goals and desires relating to career and profession after college graduation (e.g., a profile matcher matching personality traits and career, work-life balance). The high school academic credential questions may include questions about: SAT score, ACT score, PSAT score, high school class rank, and grade point average. The financial resources questions may include questions about: outside money sources, employment/work, scholarships, grants, money from parents/family, and savings. The financial resource questions also may include one or more questions/criteria about: student loan limitations, return on investment requirements, and ability to pay bills upon graduation. The college “fit” criteria/objectives questions include: location category, student body category and culture/activity category. The location questions including questions about setting (city, suburb, rural), distance from home (zip code), U.S. region, the student body questions including questions about student enrollment (size), religious affiliation, racial diversity, and the culture/activity category questions including questions about Greek life, extra-curricular activity, sports culture, availability of sport programs, and availability of study abroad programs. The questions also include importance questions about the importance of each of the questions asked, such as a question about the importance of education quality versus financial considerations and a question about the importance of college fit relative to financial considerations. These importance questions weight the significance of the question as part of the broader calculation. The college goals and desire questions include questions about: college major and preferred lifestyle after graduation (e.g., work/life balance).

5B. Scoring: Calculating three scores (academic, financial and fit) of each higher education school of a plurality of higher education schools based on the answers to the questions and based on the importance of academics, financial considerations and college “fit” criteria/objectives. Calculating an overall score based on the calculated three scores. The financial scoring includes calculating how much money each school costs for a four year degree (gross cost), how much money a user/student has available to spend (excluding student loans but including outside money sources, scholarships, grants, savings, employment/work, parent/family money), a net college cost (how much money is required to pay for the college after all money sources are applied), projected student loan amounts (the balance of money remaining after all money sources have been applied to the gross cost of college), and projected post-graduation revenue (e.g., a salary (such as a 1st year salary) projected over the course of a career adjusted for the premium).

According to an embodiment, an adjusted projected post-graduation revenue may be based on a “megatrend” analysis (e.g., when a major leads to a booming industry, a “premium” or “multiplier” may be used to adjust the projected post-graduation revenue). A major leading to a booming industry may be any industry with an employment rate above a threshold (e.g., an employment rate above 90%). Majors that commonly lead to these industries may receive a higher earnings projection.

A present career earnings value is calculated based on the projected post-graduation revenue. A financial return on investment is calculated based on these calculations.

5C. Creating a Personalized Ranked List of Schools Based on the Scorings: Rank each of the plurality of schools in the three categories (academic, financial and fit) and based on the overall score (based on all categories).

5D. Display a Dashboard including a subset of the Personalized Ranked List of Schools: That is, display an ordered list of recommended higher education schools (to apply to) that is ordered based on the rank. The dashboard is toggled between an overall ranking tab, a finance ranking tab, an academic ranking tab, a fit ranking tab and a financial strategies tab. The overall ranking ranked list/tab includes a ranked list based on all three categories (finance, academic, fit) an indication of a probability of admission category and a ranking within each likelihood of admission category, the likelihood of admission category being one of match, safety, and reach, and a recommendation on whether to apply or not apply to each college. The overall ranking ranked list/tab includes a button that causes display of another list of schools that are close but excluded from the first list and the reason for exclusion. The finance ranking tab displays a ranked list based on financial considerations/score and a remaining balance for each school (how much is needed for cost of college degree (4 years at school) based on expected financial circumstances). The fit ranking tab displays a ranked list based on a college's fit and includes an indication of a number of student responses that don't match (mismatches). The financial strategies tab displays strategies to mitigate the remaining balance (strategies include work in college, 2 years at community college, graduate in 3 years, and community college and work in college). Re-scoring/re-ranking occurs based on clicking “apply” on one of the strategies.

Accordingly, an aspect of the disclosure is to provide a responsive server method including: a real time server system method performed by a hardware server system. The real time server system method may include providing access to a database stored in a memory. The database may store student profile information and school information, and the user profile information may include an associated threshold budget and personalized school ranking information, and the school information may include, of each respective educational institution of a plurality of educational institutions, financial rating information and an expected financial cost of attendance.

The responsive server method may include accessing the database to obtain the personalized school ranking information; displaying, on a display screen of an electronic computing device, a first user interface displaying a first list of recommended educational institutions in a ranked order based on the personalized school ranking information with a highest ranked educational institution at the top followed below by increasingly lower ranked educational institutions; displaying, on the display screen of the electronic computing device, a second user interface including one or more interactive elements, the one or more interactive elements corresponding to one or more selectable optional financial reduction strategy buttons; based on identifying a user selection of one of the interactive elements: calculating a value corresponding to the user selection of one of the interactive elements; updating the threshold budget in the database based on the financial reduction strategy corresponding to the user selection of one of the interactive elements; determining, with respect to each of the plurality of educational institutions, whether the respective financial cost of attendance is equal to or below the updated threshold budget; identifying a subset of the plurality of educational institutions that includes, from among the plurality of educational institutions, those educational institutions having a respective expected financial cost of attendance that is equal to or below the updated threshold budget; calculating, based at least in part on the financial rating information, a ranking of each of the educational institutions of the subset; generating second recommendation list information that includes a second list of recommended educational institutions in a ranked order based on the calculated ranking of each of the educational institutions of the subset with a highest ranked educational institution at the top followed below by increasingly lower ranked educational institutions; storing the second recommendation list information in the memory; and displaying, on the display screen of the electronic computing device, a third user interface including the second list of recommended educational institutions in a ranked order based on the personalized school ranking information with a highest ranked educational institution at the top followed below by increasingly lower ranked educational institutions.

The methods may further include accessing the database to obtain the data used for calculation or display including personalized school ranking information. The real time server system method may further comprise: before accessing the database to obtain the school financial rating information of the subset of the plurality of educational institutions: extracting, from an external government website or server (e.g., from a U.S. Department of Education server) and/or an external private server or website, the respective expected school financial cost of attendance information of each of the plurality of educational institutions; and storing, in the database, the extracted expected school financial cost of attendance information.

The real time server system method may further comprise: prior to providing access to the database: receiving user input corresponding to at least a part of the associated threshold budget; and storing the user input corresponding to the associated threshold budget in the database in association with the user profile. The real time server system method may further comprise: accessing, from the database, salary information corresponding to an expected salary (e.g., a first-year salary, or mid-career salary) of a specified degree offered by one or more educational institutions of the plurality of educational institutions; calculating, based on the expected first year salary of the specified degree, an expected lifetime earnings corresponding to the specified degree; calculating an expected return on investment (ROI) on the specified degree of each of the plurality of educational institutions that offer the specified degree, based on the expected lifetime earnings corresponding to the specified degree and the financial cost of attendance information; and determining the financial rating information of each of the plurality of educational institutions based on the calculated expected ROI.

The real time server system method may further comprise: prior to providing access to the database: receiving user input corresponding to a designation of the specified degree; and storing an indication of the specified degree in the database in association with the user profile. The salary information may be calculated based on expected salary information (e.g., first-year salary information) extracted from at least one of a government server, a private server, or a website, the expected first-year salary information corresponding to an expected salary of an entry level graduate having the specified degree.

The calculating the expected lifetime earnings corresponding to the specified degree may include projecting earnings over a career based on the expected first year salary of the specified degree and an expected salary increase (e.g., flat annual salary increase, an inflation adjusted annual salary increase) during the career. For example, the expected salary increase may be 5% or 8% with or without adjustment for inflation.

The “over a career” may correspond to an average number of years of a career of a person corresponding to the user profile. For example, a profile of a woman may have a different average number of years of a career compared to a profile of a man.

The calculating the expected ROI may include one of: (A) calculating how much more the expected lifetime earnings corresponding to a graduate having the specified degree is compared to an expected lifetime earnings of a person who does not attend college; or (B) subtracting the expected financial cost of attendance from the expected lifetime earnings.

The real time server system method may further comprise: prior to providing access to the database: receiving one or more user inputs corresponding to an expected contribution to the threshold budget; calculating a total expected contribution to the threshold budget based on the received one or more user inputs corresponding to the expected contribution; adjusting the threshold budget based on the total expected contribution to the threshold budget; and storing the adjusted threshold budget in the database.

The response to identifying the user selection of the one of the interactive elements includes displaying the calculated value corresponding to the selected interactive element after calculating the value corresponding to the selected interactive element.

The response to identifying the user selection of the one of the interactive elements includes displaying, in a pop-up window or a different user interface, a calculator user interface configured to receive a user input corresponding to a user-entered value, and the calculated value corresponding to the selected interactive element corresponds to the user-entered value.

The real time server system method may further comprise: calculating a remaining balance of at least one educational institution of the subset by subtracting the total expected contribution to the threshold budget from the respective financial cost of attendance of each educational institution of the subset; storing the remaining balance of the at least one educational institution of the subset in the database in association with the user profile; and displaying, on the display screen of the electronic computing device, the third user interface including displaying, adjacent to the respective educational institution, the calculated remaining balance of the at least one educational institution of the subset.

The real time server system method may further comprise: receiving one or more user inputs corresponding to one or more educational institution attributes; and storing, in the database in association with the user profile, the one or more educational institution attributes, wherein the calculating, based at least in part on the corresponding financial rating information, the ranking of each of the educational institutions of the subset includes calculating the ranking of each of the educational institutions of the subset based on how closely the one or more user inputs corresponding to the one or more educational institution attributes corresponds to the respective educational institution information of respective educational institutions of the plurality of educational institutions compared to other educational institutions of the plurality of educational institutions.

The one or more educational institution attributes may include at least one of: a location, a population density setting (e.g., urban or rural setting), a distance from home, a region, a student enrollment, a religious affiliation, racial diversity, Greek life, an extra-curricular activity, or a sports culture.

The real time server system method may further comprise: receiving one or more user inputs corresponding to user desired academic quality information; and storing, in the database in association with the user profile, the user desired academic quality information, wherein the database further stores respective educational institution academic quality information in association with each of the plurality of educational institutions, and the calculating, based at least in part on the corresponding financial rating information, the ranking of the educational institutions includes calculating the ranking of the educational institutions based on how closely the user desired academic quality information corresponds to the respective educational institution academic quality information of respective educational institutions of the plurality of educational institutions compared to other educational institutions of the plurality of educational institutions.

The one or more user inputs corresponding to user desired academic quality information may include one or more of: a grade point average, a standardized test score, a different measure of academic quality, or a combination thereof.

The selectable optional financial reduction strategies buttons may include one or more of the following strategies: a work in college strategy, attending community college strategy (e.g., spending at least one year at a community college strategy), an accelerated graduation strategy (e.g., a graduate within three years or three and a half years strategy), a scholarship/grant strategy, a pre-college credits strategy, an out-of-state college reciprocity strategy (qualify for in-state tuition, such as a neighboring state offering a major that an in-state school does not offer), an attaining in-state residency strategy, a college money saving activities strategy, in-state tuition eligibility strategy (e.g., based on residence), or a college money generating activities strategy.

The selectable optional financial reduction strategies buttons may include one or more of the following strategies: a work in college strategy, a work-study program strategy, a paid internship strategy, a paid externship strategy, a residential assistant strategy, a federal scholarship strategy, a state scholarship strategy, a private grant strategy, an Advanced Placement credit strategy, a College Level Examination Program strategy, an International Baccalaureate strategy, a dual enrollment strategy, a summer classes strategy, a military program strategy, a Reserve Officers' Training Corps (ROTC) strategy, a living at home strategy, a reducing room and board expense strategy, a spending two years at a community college strategy, a graduate within three years strategy, a scholarship strategy, a pre-college credits strategy, a college money generating activities strategy, attending an out-of-state college with reciprocity strategy, or an attaining in-state residency strategy.

An embodiment may include a non-transitory computer-readable medium comprising computer-executable instructions that, when executed by processing circuitry, cause the processing circuitry to perform the real time responsive server system method (e.g., as described above or of one or a combination of FIGS. 2-4).

An embodiment of the disclosure may include a responsive server system, which may comprise: a memory; and hardware processing circuitry. The hardware processing circuitry may be configured to execute computer-executable instructions stored in the memory, which when executed by the processing circuitry, perform the following operations: providing access to a database stored in a memory, wherein the database stores student profile information and school information, wherein the user profile information includes an associated threshold budget and personalized school ranking information, and the school information includes, of each respective educational institution of a plurality of educational institutions, financial rating information and expected financial cost of attendance; accessing the database to obtain the personalized school ranking information; displaying, on a display screen of an electronic computing device, a first user interface displaying a first list of recommended educational institutions in a ranked order based on the personalized school ranking information with a highest ranked educational institution at the top followed below by increasingly lower ranked educational institutions; displaying, on the display screen of the electronic computing device, a second user interface including one or more interactive elements, the one or more interactive elements corresponding to one or more selectable optional financial reduction strategy buttons; based on identifying a user selection of one of the interactive elements: calculating a value corresponding to the user selection of one of the interactive elements; updating the threshold budget in the database based on the financial reduction strategy corresponding to the user selection of one of the interactive elements; determining, with respect to each of the plurality of educational institutions, whether the respective financial cost of attendance is equal to or below the updated threshold budget; identifying a subset of the plurality of educational institutions that includes, from among the plurality of educational institutions, those educational institutions having a respective expected financial cost of attendance that is equal to or below the updated threshold budget; calculating, based at least in part on the financial rating information, a ranking of each of the educational institutions of the subset; generating second recommendation list information that includes a second list of recommended educational institutions in a ranked order based on the calculated ranking of each of the educational institutions of the subset with a highest ranked educational institution at the top followed below by increasingly lower ranked educational institutions; storing the second recommendation list information in the memory; and displaying, on the display screen of the electronic computing device, a third user interface including the second list of recommended educational institutions in a ranked order based on the personalized school ranking information with a highest ranked educational institution at the top followed below by increasingly lower ranked educational institutions.

According to an embodiment, a networked server system may comprise: a first electronic display device configured to cause a processor of the first electronic display device to control a first display to display a first set of user interface (UI) screens, wherein the first set of UI screens include a first user interface screen displaying a list of recommended colleges, a second user interface screen displaying optional strategies for reducing student loans and/or overall college costs, the optional strategies including one or more optional strategies of: a work in college strategy, spending two years at a community college strategy, graduating within three years strategy, or a combination of work and community college strategy, and when a user clicks on one of the one or more optional strategies, identify one of the optional strategies as corresponding to a user input selection, update the list of recommended colleges to account for the relevant strategy corresponding to the user input selection, and provide a third user interface screen that displays the updated list of recommended colleges re-ranked based on the user input selection of one of the optional strategies. The first electronic display device may operate in cooperation with the server to display any of the user interfaces discussed herein.

According to an embodiment, a networked server system may comprise: a first electronic display device configured to cause a processor of the first electronic display device to control a first display to display a first set of user interface (UI) screens, wherein the first set of UI screens include a dashboard user interface screen that includes two portions, the two portions corresponding to a nested UI, the first portion being a static border menu that displays buttons corresponding to a list of different types of recommendation rankings, and the second portion being toggleable between different sub-screens, each sub-screen corresponding to a different type of recommendation ranking, wherein the first portion displays two or more buttons, the two or more buttons including two or more of: an overview rankings button, a finance rankings button, an academic rankings button and a fit rankings button, wherein when a first button of the two or more buttons is clicked, the second portion displays a first list that includes a first ranked set of recommend schools, wherein when a second button of the two or more buttons is clicked, the second portion displays a second list that includes a second ranked set of recommended schools, wherein the first button is different than the second button, and the first list is different than the second list.

According to an embodiment, a networked server system may comprise: a first electronic display device configured to cause a processor of the first electronic display device to control a first display to display a first set of user interface (UI) screens, wherein the first set of UI screens are configured to display a list of ranked schools, and simultaneously display, for each school, an indication of an admission probability level and a recommendation for application, from among safety level, match level and reach level, wherein the admission probability level is determined, for the student, based at least in part on a user-entered standardized test score, class rank, and/or grade point average compared to each school's statistics on admitted students, wherein the safety level has a highest probability of admission, the reach level has the lowest probability of admission, and the match level has a probability of admission that is between the highest probability of admission and the lowest probability of admission, wherein the indication of admission probability level is color-coded, the color green is displayed when the school corresponds to the safety level, the color yellow is displayed when the school corresponds to the match level and the color red is displayed when the school corresponds to the reach level.

In the calculations for the overview rankings sub-screen and the financial rankings sub-screen, the financial scoring may include calculating how much money each school costs for a four year degree (gross cost), how much money a user/student has available to spend (excluding student loans but including outside money sources, scholarships, grants, savings, employment/work, parent/family money), a net college cost (how much money is required to pay for the college after all money sources are applied), projected student loan amounts (the balance of money remaining after all money sources have been applied to the gross cost of college), and projected post-graduation revenue (salary information projected over the course of career which may be adjusted for the premium).

On the financial rankings sub-screen, a remaining balance of a cost of college may be displayed where the remaining balance of the cost of college factors in a prospective student's expected contribution to the cost of college, which is based on stored user input (e.g., survey data).

In the fit rankings sub-screen, an indication of a first fit preference that has a highest fit and an indication of a second fit preference that has a lowest fit may be displayed.

In the fit rankings sub-screen, a total number of fit preferences that do not match the user-entered fit preferences (mismatches) may be displayed.

In addition, the admission probability level may include a recommendation on an application and/or a level ranking corresponding to a school's rank within that admission probability level. For example, the safety schools may be ranked 1-3, the match schools may be ranked 1-3 and the reach schools may be ranked 1-3. The individual level ranking may also be displayed.

An excluded colleges screen. Showing students other colleges that may be considered (could be recommended) but are not because of a student's specific survey response (i.e. an “Excluded Colleges” page), including an indication of the reason for exclusion.

According to an aspect of the disclosure, a non-transitory computer-readable medium may be provided that comprises computer-executable instructions that, when executed by processing circuitry, cause the processing circuitry to perform the real time responsive server method and/or the electronic device method.

According to an embodiment, a real time server system method performed by a server system may comprise: providing access to a database stored in a memory, wherein the database stores a user profile including an associated threshold cost of attending, and the database stores, in association with each respective educational institution of a plurality of educational institutions, respective financial rating information and a respective financial cost of attending; accessing the database to obtain the respective financial cost of attending of at least some of the plurality of educational institutions and the threshold cost of attending associated with the user profile; determining, for each of the at least some of the plurality of educational institutions, whether the respective financial cost of attending is above a threshold cost of attending; identifying a first subset of the plurality of educational institutions that includes, from the at least some of the plurality of educational institutions, those educational institutions having a respective financial cost of attending that is below the threshold cost of attending; accessing the database to obtain the financial rating information of the first subset of the plurality of educational institutions; calculating, based at least in part on the corresponding financial rating information, a ranking of each of the educational institutions of the first subset; generating first recommendation list information that includes recommended educational institutions in a top-down order based on the calculated ranking with a highest ranked educational institution at the top followed below by increasingly lower ranked educational institutions; storing the first recommendation list information in the memory; displaying, on a display screen of an electronic computing device, a first user interface including a first list of recommended educational institutions that corresponds to the first recommendation list information; displaying, on the display screen of the electronic computing device, a second user interface including one or more interactive elements, the one or more interactive elements corresponding to selectable optional financial reduction strategies buttons; in response to determining a user interaction with one of the interactive elements: calculating or determining a value corresponding to the selected interactive element; and revising the threshold cost of attending by adding the value corresponding to the selected financial reduction strategy to the threshold cost of attending; determining, for each of the at least some of the plurality of educational institutions, whether the respective financial cost of attending is above the revised threshold cost of attending; identifying a second subset of the plurality of educational institutions that includes, from the at least some of the plurality of educational institutions, those educational institutions having a respective financial cost of attending that is below the revised threshold cost of attending; accessing the database to obtain the financial rating information of the second subset of the plurality of educational institutions; calculating, based at least in part on the corresponding financial rating information, a ranking of each of the educational institutions of the second subset; generating second recommendation list information that includes recommended educational institutions in a top-down order based on the calculated ranking with a highest ranked educational institution at the top followed below by increasingly lower ranked educational institutions; storing the second recommendation list information in the memory; and displaying, on the display screen of the electronic computing device, a third user interface including a second list of recommended educational institutions that corresponds to the second recommendation list information, wherein the causing the third user interface to display the second list of recommended education institutions includes dynamically updating the first user interface to display the second recommendation list information as a replacement of the first recommendation list information.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1A illustrates a diagram of a networked computer system that may execute a method, according to an embodiment, according to an embodiment;

FIG. 1B illustrates a detailed view of an electronic computing device that can be used to implement the various components and/or methods described herein, according to certain embodiments;

FIG. 1C illustrates a detailed view of a responsive server that can be used to implement the various components and/or methods described herein, according to some embodiments;

FIGS. 2-4 each illustrate a flow chart of a real time responsive server method performed by processing circuitry, according to certain embodiments;

FIGS. 5A-5C each illustrate an electronic display device displaying a GUI on an electronic display screen, according to an embodiment;

FIGS. 6A-6B each illustrate an electronic display device displaying a GUI on an electronic display screen, according to an embodiment;

FIG. 7 illustrates an electronic display device displaying a GUI on an electronic display screen, according to an embodiment;

FIG. 8 illustrates an electronic display device displaying a GUI on an electronic display screen, according to an embodiment;

FIGS. 9A-9F each illustrate an electronic display device displaying a GUI on an electronic display screen, according to an embodiment;

FIGS. 10A-10B each illustrate an electronic display device displaying a GUI on an electronic display screen, according to an embodiment;

FIGS. 11A-11D show an example of a data table of the database which aggregates school data together, according to an embodiment; and

FIG. 12 illustrates a diagram of network requests, according to certain embodiments.

Throughout the drawings, it should be noted that like reference numbers are used to depict the same or similar elements, features, and structures.

### DETAILED DESCRIPTION OF THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness. The terminology used herein is for the purpose of referring to specific embodiments only and is not intended to limit the invention.

With reference to the accompanying drawings, the embodiments of the disclosure will be described in detail so that those of ordinary skill in the art can easily carry out the embodiments. However, the inventive concepts may be embodied in several different forms and are not limited to the embodiments described herein.

As used herein, the singular forms “a,” “an,” and “the” include the plural forms unless the context clearly indicates otherwise. Thus, for example, reference to “an element” includes reference to one or more of such elements. The meaning of “comprising,” as used herein, specifies a particular characteristic, region, integer, step, operation, element and/or component, and other specific characteristic, region, integer, step, operation, element, component, and/or group. It does not exclude the existence or addition of anything.

### Networked Computer System

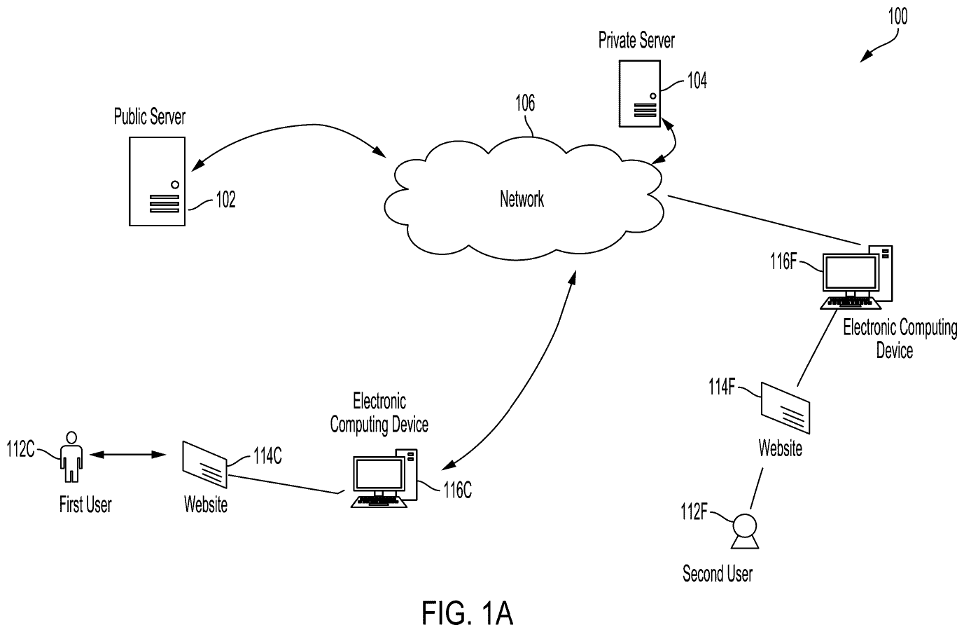

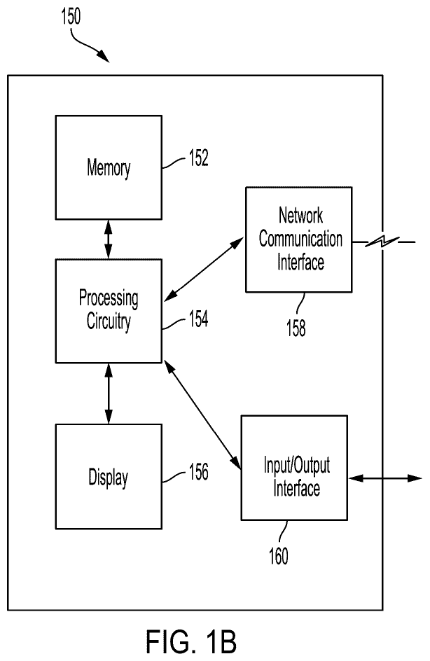

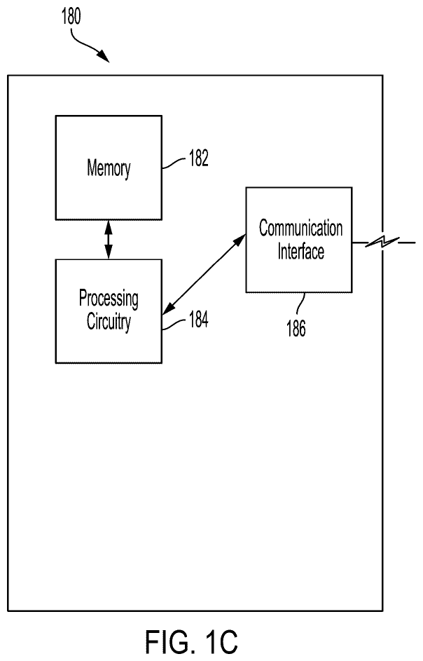

FIG. 1A illustrates a diagram of a networked computer system 100 that may execute a method according to certain embodiments. The networked computer system 100 may include one or more responsive servers (e.g., public server 102, private server 104) and one or more electronic display devices (e.g., devices 116C, 116F), which may be referred to as user terminals. Although two user terminals are shown, the number of user terminals may be more or less. Each user terminal device may be connected to one or more other user terminals and/or a responsive server(s).

The user terminals may be communicably connected (e.g., via a network 106, such as the Internet 106) to communicate with the responsive server(s) and the other user terminals. The server(s) 102 may correspond to more than one networked server, such as a social media server and a user account server, and/or may involve distributed computing, parallel computing, a virtual server(s), cloud computing and the like. Although the processing is discussed on specific devices, the processing may be distributed.

The user terminals 112C, 116F are electronic computing devices and shown as a desktop computer (with a monitor), but the user terminals may be any type of electronic computing device, such as a desktop personal computer (PC), a smartphone (mobile device), a tablet computer, a laptop computer, a personal digital assistant (PDA), an e-book reader, a connected smart speaker or a listening device, and the like.

According to an embodiment, the networked computer system 100 may include a plurality of user accounts stored in a database of the server(s). Each of the user accounts may be associated with one or more users 112C, 112F and may each correspond to a registered user account (e.g., where a User 112C, 112F logs in to access the website/applications 114C, 114F via the user terminal 116C, 116F. The server may also store one or more admin accounts for admin users to provide global updates, such as adjusting weights, or adjusting a weight adjusting algorithm, managing user accounts, etc.

The user terminals 116C, 116F may correspond to any electronic computing device that a respective user 112C, 112F is logged into. In this respect, for example, when user 112C is logged into the website or application 114C, the current electronic computing device the user 112C is using is user 112C's user terminal 116C. When user 112C logs in from a different electronic computing device, that different electronic computing device is user 112C's user terminal 116C. The software is application and/or webpage/portal driven, and hence, it does not matter which electronic computing device/user terminal a user logs into, as the application is accessible from different connected computing devices. The software corresponds to and/or includes the computer-executable instructions discussed below.

As described above, the user terminals and/or responsive servers may perform and execute various tasks, operations and/or methods described herein. The responsive server(s) may perform some or all the processing with relation to the methods performed by the user terminals (electronic computing devices).

### Electronic Device (User Terminal)

FIG. 1B illustrates a detailed view of an electronic computing device 150 that can be used to implement the various components and/or methods described herein, according to certain embodiments. Any of the user terminals 116C, 116F (and also servers 102, 104) may correspond to electronic computing device 150.

In an embodiment of the disclosure, as shown in FIG. 1B, the electronic computing device 150 may include one or more memories 152, processing circuitry 154 (e.g., a controller, a hardware processor), a display 156, a network communication interface 158, and an input/output (I/O) interface 160. The electronic computing device 150 may also include an internal or external speaker (e.g., wireless headphones speakers).

The processing circuitry 154 may include and provide functionality by way of one or more processors (e.g., a hardware processor, a virtual processor, a distributed processor, central processing units (CPUs), a specialized processor, such as a Graphics Processing Unit (GPU), and/or Application Specific Integrated Circuits (ASICs)) executing computer-executable instructions (software) embodied in one or more tangible (non-transitory), computer-readable media. The computer-readable media may correspond to one or more memories 152, which may hereinafter be referred to as a memory 152. According to an embodiment, memory 152 may be a local memory 152 or local data storage 152. According to an embodiment, the memory 152 may include one or more of: media, a storage device, memory devices or chips, internal mass storage (e.g., Read-Only Memory (ROM), a Random-Access Memory (RAM)), a Compact Disc (CD), a Digital Versatile Disc (DVD), a thumb-drive, a removable hard drive, a solid-state drive, legacy magnetic media (e.g., a tape drive, a floppy disc drive), a specialized ASIC-based device, and/or the like.

The software implementing various embodiments of the present disclosure can be stored in the memory (e.g., storage devices and/or media) and executed by processing circuitry 154. “Computer readable media” or “computer readable medium” as used in connection with the disclosure include non-transitory media, transmission media, and/or carrier waves.

The computer readable media and/or memory 152 may store computer code/instructions (software) for performing various computer-implemented functions. The computer code may include instructions that, when executed by the processing circuitry 154, causes the processing circuitry to execute various functions, processes, parts, operations and/or methods (collectively referred to hereinafter as functions or operations). Reference to a computer-readable media can include a circuit (such as an integrated circuit (IC)) storing software for execution, a circuit embodying logic for execution, or both, where appropriate. The present disclosure includes any suitable combination of hardware and software.

The various functions, operations, and methods pertinent to this disclosure are explained in detail herein. The processing circuitry 154 may be configured to perform the various operations (e.g., by being programmed to do so via computer executable instructions) discussed in more detail herein.

The electronic computing device 150 may further include a communication interface 158 electrically coupled to the processing circuitry 154. The communication interface 158 may be configured to receive data transmitted from one or more electronic end user devices (e.g., user terminal devices, the one or more electronic ring devices, and/or other electronic devices) and/or one or more servers. The communication interface 158 may include a network communication interface 158. The communication interface 158 may be configured to transmit, via, for example, control by the processing circuitry 154, data to the one or more electronic computing devices over a network (wired or wirelessly), such as, via an interface to one or more communication networks (e.g., via the communication interface 158). The processing circuitry 154 may be configured to control (or cause) the display 156 to display information, or alternatively, transmit the to-be-displayed information over the communication interface 158, or over the input/output interface 160 to another electronic computing device (e.g., smartphone, computer monitor) for external display.

As shown in FIG. 1B, the electronic computing device 150 may also include or be at least configured to be electrically connected (or wirelessly connected) to one or more electronic input/output (I/O) devices, including peripheral output devices (e.g., external, or internal). The electronic computing device 150 may use the input/output (I/O) interface 160 to communicate with one or more external peripheral devices, such as, one or more of: a display device (e.g., an external desktop monitor, a touch screen display panel, etc.), a keyboard, a microphone (e.g., for voice input), a camera (e.g., for gesture input), a mouse, a speaker, a microphone, a joystick, a scanner, a trackpad, a printer, a sensor, and/or a biometric capture device (e.g., a device that captures one or more of: fingerprint, palm print, iris information, etc.). The peripheral devices may include user input devices (e.g., a mouse, keyboard, microphone) and/or output devices (e.g., speaker, display) and may be connected to the processing circuitry 154 by the I/O interface 160 or the network communication interface 158. The electronic display device may correspond to a smartphone and/or electronic computing device and include a touch-screen display device that is configured to detect an interaction (e.g., touch, tap or long or short press) with the touchscreen, and identify information (e.g., position on the display screen) regarding the interaction. The GUIs may be used to prompt for and/or receive user input, and also provide virtual buttons for navigation to multiple different GUI screens related to the electronic device. The information displayed by the GUIs may include touch menu buttons for navigating to sub-menus.

Throughout the drawings, it should be noted that like reference numbers are used to depict the same or similar elements, features, and structures. The electronic display device may correspond to and/or be electronically coupled to the electronic computing device, and/or a server.

The I/O interface 160 may be wired (e.g., universal serial bus (USB) drive, external RAM/ROM, external processor, data port) or wireless (e.g., short-range communication protocols, syncing, Bluetooth®, radio frequency (RF), near field communication (NFC) or Wi-Fi). The I/O interface 160 may be electrically coupled to the processing circuitry 154 and the processing circuitry 154 may be configured to control (or cause) the I/O interface 160 to transmit information between the device 150 and other electronic devices or peripherals. At least a portion of the network communication interface 158 and or the I/O interface 160 may be provided on an outer surface of a housing of an electronic computing/display device (e.g., a smartphone). The network communication interface 158 and or the I/O interface 160 may include similar and/or the same overlapping functionality.

The software may cause the processing circuitry and specifically the processor(s) to execute particular processes or particular parts of particular processes described herein, including defining data structures stored in RAM and modifying data structures according to the processes defined by the software. In addition, or as an alternative, the processing circuitry may provide functionality because of logic hardwired or otherwise embodied in a circuit, which can operate in place of or together with software to execute particular processes or particular parts of particular processes described herein. Reference to software can encompass logic, and vice versa, where appropriate.

Networks may be, for example, wired, wireless, or optical. Networks can provide real-time data transfer and include a local area network (LAN), a wide-area network (WAN), and/or the Internet. Examples of networks include Ethernet, wireless LANs, cellular networks (e.g., Global System for Mobile Communications (GSM)), 3G, 4G, 5G, Long-Term Evolution (LTE).

The display 156 may include any type of display including a projector or a display screen, such as, a touch screen display panel, an organic light-emitting diode (OLED) screen, a liquid crystal display (LCD) screen, a cathode ray tube (CRT) screen, and/or augmented reality glasses. The display 156 may be electrically coupled to the processing circuitry 154 and the processing circuitry 154 may be configured to control (or cause) the display 156 to display information (e.g., display the information discussed in the methods and operations below). The display 156 may be provided on an outer surface of a housing of an electronic computing/display device (e.g., a smartphone) or be an external display monitor connected to a standalone electronic computing device (e.g., a PC connected to a monitor, where the monitor is the display).

The speaker(s) may include any type of speaker including a smartphone/tablet speaker(s) and/or wired or wireless headphone speakers (also referred to as earbuds). The speaker(s) may be electrically coupled to the processing circuitry 154 and the processing circuitry 154 may be configured to control (or cause) the speaker(s) to output sound, such as a notification. The speaker(s) may be provided on an outer surface of a housing of an electronic display device (e.g., a smartphone) or be an external speaker. The speaker may include a microphone, or a microphone may be provided separately to record sound data, such as speech data.

### Real Time Responsive Server(s)

FIG. 1C illustrates a detailed view of a responsive server 180 that can be used to implement the various components and/or methods described herein, according to an embodiment(s). The responsive server(s) 102, 104 in FIG. 1A may correspond to the responsive server 180 illustrated in FIG. 1C.

In an embodiment of the disclosure, as shown in FIG. 1C, the responsive server 180 may include one or more memories 182 (e.g., a local memory or local data storage), processing circuitry 184 (e.g., a controller, a hardware processor) and a communication interface 186 electrically coupled to the processing circuitry 184. The communication interface 186 may be configured to receive data transmitted from one or more external electronic computing devices (e.g., electronic computing devices 116C, 116F), and/or one or more other servers.

The processing circuitry 184 may be configured to store, in memory 182, data received from various sources over the network. For example, processing circuitry 184 may be configured to store information received as data received from the communication interface 186.

The responsive server 180 may be configured to provide automatic real time updates to the respective electronic computing devices, as discussed below. Real time may correspond to instantaneous, near real time (near instantaneous) or a combination thereof. The processing circuitry 184 may be connected to each of the other components of the server(s) 180 and may communicate, via communication interface 186, with one or more of the components of the electronic device 150 of FIG. 1B. The communication interface 186 may correspond to and include the same functionality as network communication interface 158 and/or I/O interface 160 discussed above.

### Real Time Server System Method

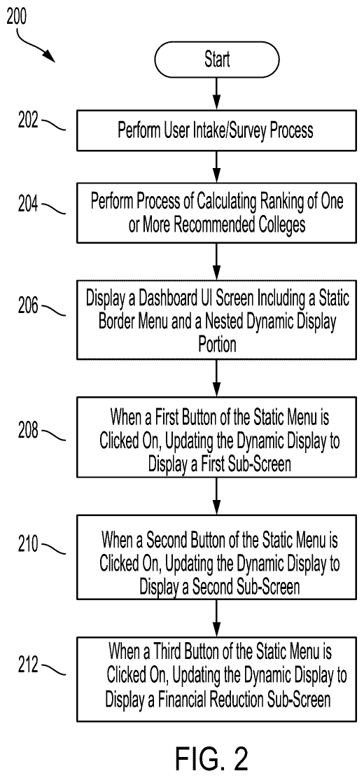

According to an embodiment, the processing circuitry may be configured to perform a real time responsive server method. FIGS. 2-4 illustrate real time responsive server system methods 200-400, respectively.

FIG. 2 illustrates a flow chart of a real time responsive server method 200 performed by processing circuitry, according to certain embodiments. With reference to FIG. 2, according to an embodiment, the processing circuitry may be configured to perform a real time responsive server system method 200 of controlling a display of an electronic device, including one or more of the following Operations 202-210. For example, the operations may include: performing a user intake/survey process (Operation 202), which may include collecting (e.g., obtaining or accessing) and storing, by the server system, in a database of a memory, intake/survey user data corresponding to user input of a user. The user may correspond to a registered device user.

The method 200 may further include performing a process of calculating one or more ranking(s) of one or more recommended colleges (Operation 204), which may include the server accessing and analyzing the stored data. Based on the analysis, the server may calculate a ranking of the schools based on the analyzing of the stored data (Operation 204). The term college, educational institution and school may be used interchangeably herein.

Operation 206 may include displaying a dashboard user interface (UI) screen including a static border menu and a nested dynamic display portion.

When a first button of the static menu is clicked on, the server may update the dynamic display to display a first sub-screen (Operation 208).

When a second button of the static menu is clicked on, the server may update the dynamic display to display a second sub-screen (Operation 210).

When a third button of the static menu is clicked on, the server may update the dynamic display to display a financial reduction strategy sub-screen (Operation 212).

### Method of Generating and Displaying a List of Recommended Colleges

According to an embodiment, the processing circuitry may be configured to perform a real time responsive server method 300.

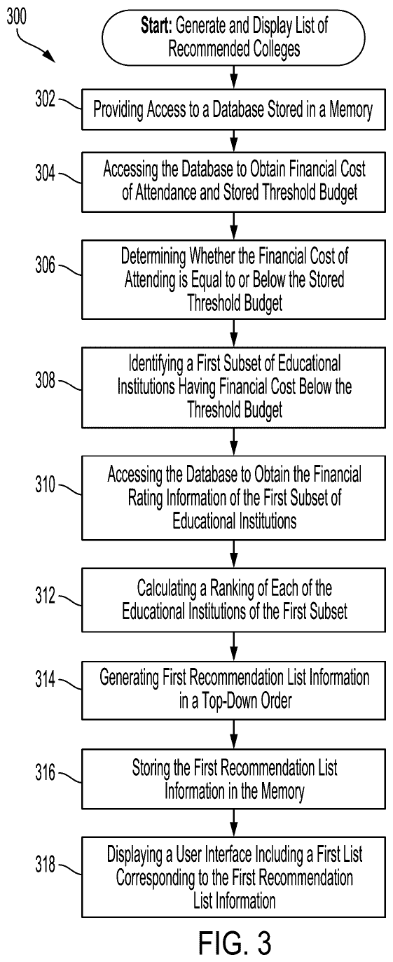

FIG. 3 illustrates a flow chart of a real time responsive server method 300 performed by processing circuitry, according to certain embodiments. With reference to FIG. 3, according to an embodiment, the processing circuitry may be configured to perform a real time responsive server system method 300 of controlling a display of an electronic device, including one or more of the following Operations 302-318. For example, the operations may include: providing access to a database stored in a memory (Operation 302). The database may store student profile information and school information, and the user profile information may include an associated threshold budget and personalized school ranking information, and the school information may include, of each respective educational institution of a plurality of educational institutions, financial rating information and expected financial cost of attendance.

The method 300 may further include accessing the database to obtain financial cost of attendance and the stored threshold budget (Operation 304) and determining, with respect to each of the plurality of educational institutions, whether the respective financial cost of attendance is equal to or below the threshold budget (Operation 306).

The method 300 may further include identifying a subset of the plurality of educational institutions that includes, from among the plurality of educational institutions, those educational institutions having a respective expected financial cost of attendance that is equal to or below the relevant threshold budget (Operation 308).

The method 300 may further include accessing the database to obtain the financial rating information of the first subset of educational institutions (Operation 310). Method 300 may further include calculating, based at least in part on the financial rating information, a ranking of each of the educational institutions of the subset (Operation 312).

The method 300 may further include generating first recommendation list information in a top-down order (Operation 314), storing the first recommendation list information in the memory (Operation 316), and displaying a user interface including a first list corresponding to the first recommendation list information (Operation 318).

### Method of Providing a User-Selected Financial Strategy-Based Update

According to an embodiment, the processing circuitry may be configured to perform a real time responsive server method 400.

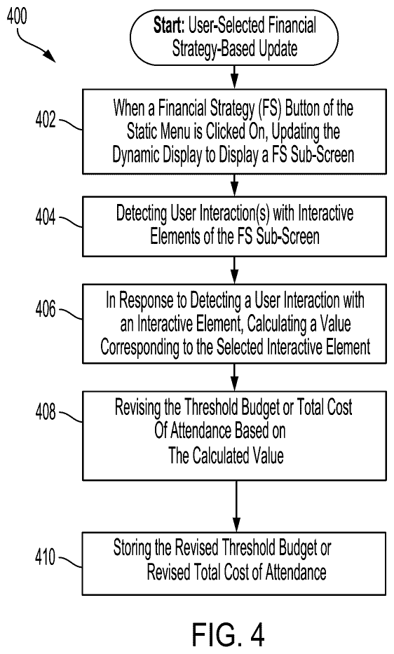

FIG. 4 illustrates a flow chart of a real time responsive server method 400 performed by processing circuitry, according to certain embodiments. With reference to FIG. 4, according to an embodiment, the processing circuitry may be configured to perform a real time responsive server system method 400 of controlling a display of an electronic device, including one or more of the following Operations 402-418. The operations 402-418 may performed after or in conjunction with the Operations of FIGS. 2 and 3. For example, Operation 402 may correspond to Operation 212 of FIG. 2.

Operation 402 may include updating a dynamic display screen to display a financial strategy reduction sub-screen when a financial strategy (FS) button of the static menu is clicked on. Operation 402 may include displaying, on the display screen of the electronic computing device, a second user interface (display areas 520A with display areas 520B-6 or 520B-7) including one or more interactive elements, the one or more interactive elements corresponding to one or more selectable optional financial reduction strategy buttons.

Operation 404 may include detecting user interaction(s) with interactive elements of the FS sub-screen.

Operation 406 may include calculating a value corresponding to the selected interactive element in response to detecting a user interaction with an interactive element. Operation 406 may include based on identifying a user selection of one of the interactive elements: calculating a value corresponding to the user selection of one of the interactive elements.

Operation 408 may include revising the threshold budget or total cost of attendance based on the calculated value. Operation 408 may include updating the threshold budget in the database based on the financial reduction strategy corresponding to the user selection of one of the interactive elements.

Operation 410 may include storing the revised threshold budget or revised total cost of attendance in the database.

Method 400 may also include determining, with respect to each of the plurality of educational institutions, whether the respective financial cost of attendance is equal to or below the updated threshold budget; identifying a subset of the plurality of educational institutions that includes, from among the plurality of educational institutions, those educational institutions having a respective expected financial cost of attendance that is equal to or below the updated threshold budget; calculating, based at least in part on the financial rating information, a ranking of each of the educational institutions of the subset; generating second recommendation list information that includes a second list of recommended educational institutions in a ranked order based on the calculated ranking of each of the educational institutions of the subset with a highest ranked educational institution at the top followed below by increasingly lower ranked educational institutions; storing the second recommendation list information in the memory; and displaying, on the display screen of the electronic computing device, a third user interface including the second list of recommended educational institutions in a ranked order based on the personalized school ranking information with a highest ranked educational institution at the top followed below by increasingly lower ranked educational institutions.

The methods may further include accessing the database to obtain the data used for calculation or display including personalized school ranking information. The real time server system method may further comprise: before accessing the database to obtain the school financial rating information of the subset of the plurality of educational institutions: extracting, from an external government server or website (e.g., from a U.S. Department of Education server) or a private server or website, the respective expected school financial cost of attendance information of each of the plurality of educational institutions; and storing, in the database, the extracted expected school financial cost of attendance information.

The real time server system method may further comprise: prior to providing access to the database: receiving user input corresponding to at least a part of the associated threshold budget; and storing the user input corresponding to the associated threshold budget in the database in association with the user profile. The real time server system method may further comprise: accessing, from the database, salary information corresponding to an expected salary (e.g., a first-year salary, or mid-career salary) of a specified degree offered by one or more educational institutions of the plurality of educational institutions; calculating, based on the expected first year salary of the specified degree, an expected lifetime earnings corresponding to the specified degree; calculating an expected return on investment (ROI) on the specified degree of each of the plurality of educational institutions that offer the specified degree, based on the expected lifetime earnings corresponding to the specified degree and the financial cost of attendance information; and determining the financial rating information of each of the plurality of educational institutions based on the calculated expected ROI.

The calculating the expected ROI may include one of: (A) calculating how much more the expected lifetime earnings corresponding to a graduate having the specified degree is compared to an expected lifetime earnings of a person who does not attend college; or (B) subtracting the expected financial cost of attendance from the expected lifetime earnings.

The method(s) may further include prior to providing access to the database: receiving user input corresponding to a designation of the specified degree; and storing an indication of the specified degree in the database in association with the user profile. The salary information may be calculated based on expected first-year salary information extracted from at least one of a government server, a private server or a website, the expected salary information corresponding to an expected salary of a graduate having the specified degree (e.g., an entry level or a mid-career graduate).

The method(s) may further include prior to providing access to the database: receiving one or more user inputs (e.g., via the survey discussed below) corresponding to an expected contribution to the threshold budget; calculating a total expected contribution to the threshold budget based on the received one or more user inputs corresponding to the expected contribution; adjusting the threshold budget based on the total expected contribution to the threshold budget; and storing the adjusted threshold budget in the database.

The response to identifying the user selection of the one of the interactive elements includes displaying the calculated value corresponding to the selected interactive element after calculating the value corresponding to the selected interactive element.

The response to identifying the user selection of the one of the interactive elements includes displaying, in a pop-up window or a different user interface, a calculator user interface configured to receive a user input corresponding to a user-entered value, and the calculated value corresponding to the selected interactive element corresponds to the user-entered value.

The calculating a remaining balance of at least one educational institution of the subset may include subtracting the total expected contribution to the threshold budget from the respective financial cost of attendance of each educational institution of the subset; storing the remaining balance of at least one educational institution of the subset in the database in association with the user profile; and displaying, on the display screen of the electronic computing device, the third user interface including displaying, adjacent to the respective educational institution, the calculated remaining balance of the at least one educational institution of the subset.

### User Interfaces Related to the Responsive Server Method

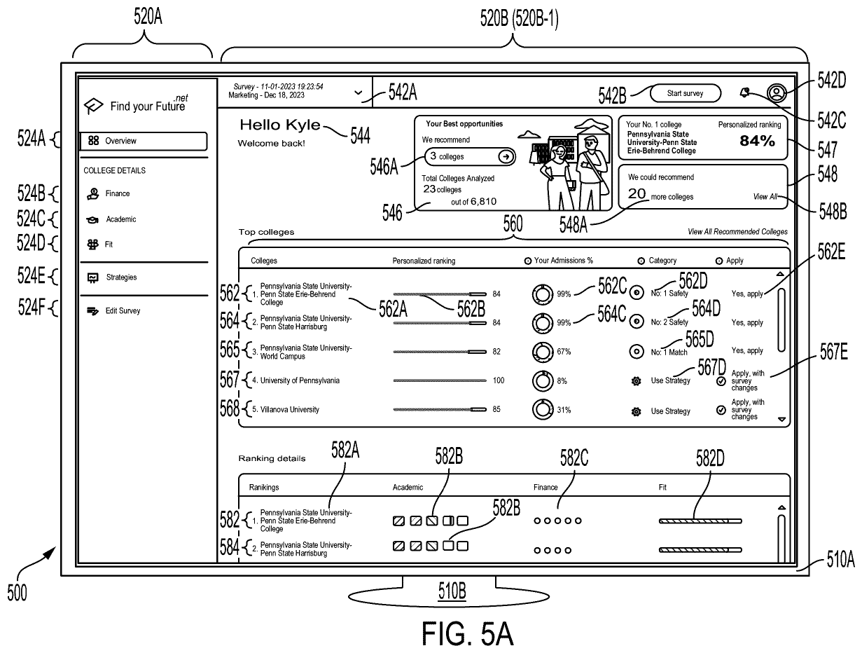

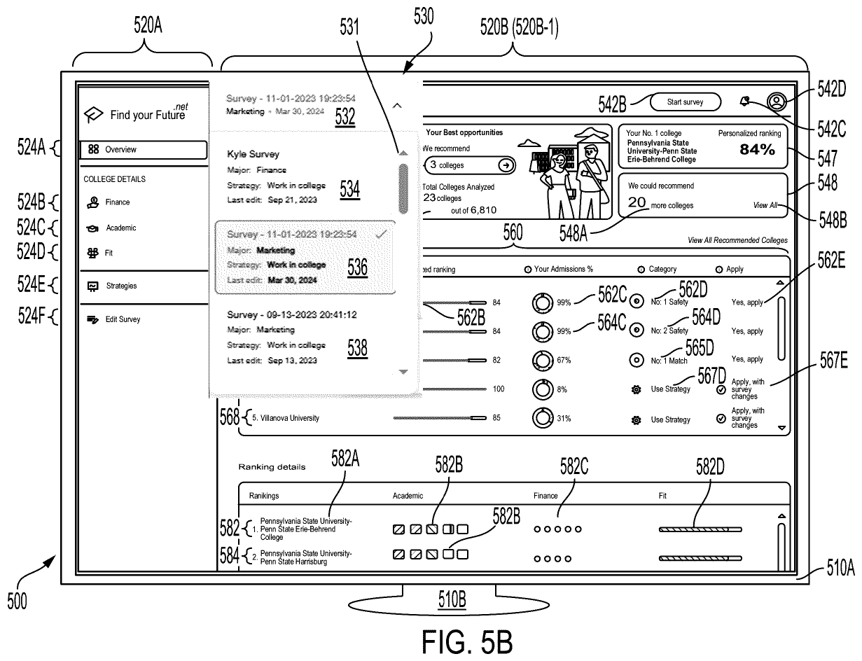

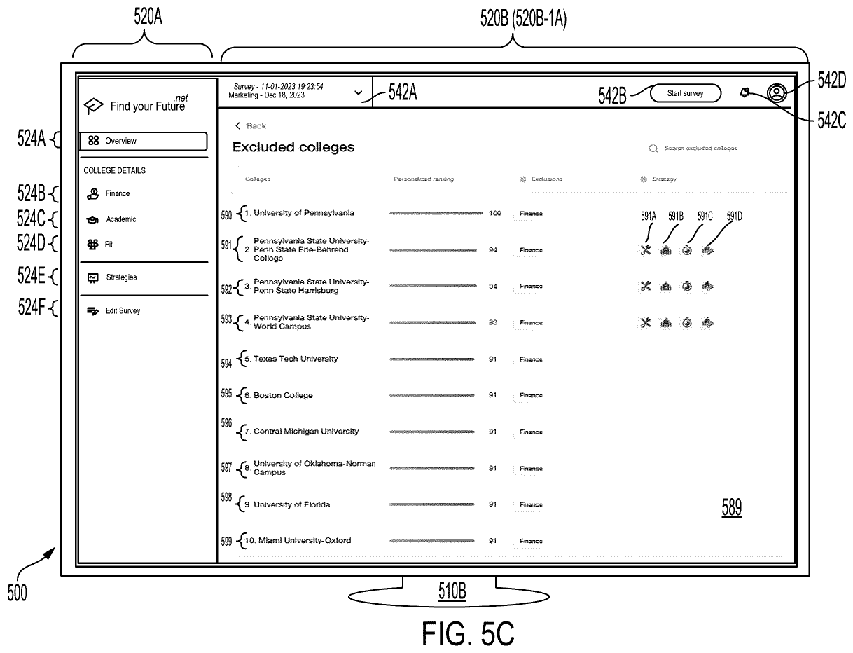

FIGS. 5A-10B show different versions of graphical user interfaces (GUIs) that correspond to displaying information, by an electronic device or an external monitor communicatively coupled to the electronic device, related to the responsive server method.

FIG. 5A illustrates an electronic display device 500 displaying an example of a user interface GUI 520 (comprising display portions 520A and 520B) on an electronic display screen 510A, according to an embodiment. The electronic display device 500 may be a part of a mobile device/smartphone (not shown) or be a computer monitor 510 having a display screen 510A and a monitor stand 510B. The computer monitor may be communicatively coupled to an electronic device.

The electronic display device 500 may correspond to and/or be electronically coupled to the electronic computing device 150 and/or the server 180. Nested GUI, as used herein, may correspond to a GUI with a menu bar portion (e.g., a menu panel and/or a status bar) and a dynamic display portion (e.g., a dynamic display portion first displays a sub-screen followed by a sub screen corresponding to a button click in the menu bar portion).

The GUI 520 may be a nested GUI and may include a vertically-extending menu bar column 520A, and a dynamic display area 520B.

The menu bar portion 520A may include a company logo (shown as “Find your Future.net”), and interactable hyperlinked buttons 524A-524F. The interactable buttons 524A-524F may be buttons (e.g., text or icon buttons) and cause the dynamic display area 520B to display certain types of information and/or different GUIs (or sub-screens) based on (e.g., in response to) user interaction with the button (e.g., when the button is activated).

The buttons may be hyperlinked to other webpages/GUI screens or sub-screens and transition between webpage/GUI screens or sub-screens within a respective application/website. For example, when the button 524A is clicked on, the sub-screen (or display portion) 520B-1 of FIG. 5A may be displayed.

The menu bar portion 520A may include an overview button 524A, a finance button 524B, an academic button 524C, a fit (preferences) button 524D, a strategies button 524E and an edit survey button 524F. The menu bar portion may include a box surrounding the currently selected button. For example, in FIG. 5A, the overview button is currently selected.

The overview button 524A (when selected) may cause the overview sub-screen 520B-1 to be displayed. FIG. 5A shows an example of the “overview” sub-screen 520B-1.

The overview sub-screen 520B-1 may include a survey toggle box 542A, a start new survey button 542B, a notifications bell button 542C and a profile settings button 542D.

The survey toggle box 542A may cause a drop-down menu to be displayed that allows a user to select a different survey (which causes the personalized data to be changed to correspond to the survey information selected) and the start new survey button 542B may cause a series of interactive GUIs to be displayed in question and answer format to obtain information (survey data) from a user. Each instance of a selected survey causes the survey toggle box 542A to display survey information about the currently selected survey. The survey information may include data and time of creation (e.g., 11-01-23 19:23:54), selected Major: Marketing, selected Strategy if applicable (e.g., Work in college) and a last edit date: Dec. 18, 2023). Each logged in user may cycle through different surveys and each survey corresponds to at least one major. Each user profile has different surveys. This feature allows users to access a different database or data set. The same input they walk through with the original survey can be duplicated. Allows users to play with the data. The adjustments to populate the new data set.

When survey toggle box 542A is clicked on, a drop-down menu of surveys may be displayed. For example, FIG. 5B shows a drop-down menu 530 of surveys that is displayed in response to 542A being clicked on. The drop-down menu 530 of surveys may include survey display information 532 regarding a currently selected survey, and a plurality of selectable surveys 534, 536, 538. The selectable surveys 534, 536 and 538 may include the survey information discussed above (e.g., date and time of creation, major, selected strategy (if applicable) and last edit date). Selectable survey 536 further includes distinguishing characteristics (e.g., a checkmark in the top right corner, bolding of the survey information, a color change and a pronounced border) that indicate it is currently selected and distinguish the selectable survey 536 from the not currently selected surveys 534 and 538. The drop-down menu 530 may be a pop-up window or overlay and may include a scroll bar 531 that, when moved, causes additional selectable surveys to be displayed. Each selectable survey corresponds to a data set instance. When a survey is selected (i.e., moving from unselected to currently selected), at three operations occur: (i) the drop-down menu 530 modifies the display characteristics of the previously-selected survey to be normal/unselected (e.g., as shown for surveys 534 and 538), (ii) the newly selected survey is modified to include the distinguishing characteristics, and (iii) the underlying active data driving the responsive server methods, operations and/or algorithms is switched from one student-school profile to another. That is, for example, when the underlying active data set is switched, all of the personalized values used for evaluation purposes from the data table/data set 1100 may be switched. Thus, with the survey toggle box 542A, a logged in user (e.g., Kyle) may, in real time, make a quick switch to the active data set, and subsequently make rapid adjustments to the active data set (e.g., using the edit survey button). The survey questions allow piecemeal changes (one at a time) but the survey toggle box 542A allows for wholesale (whole person) changes with one click.

The notifications bell button 542C may cause a notification pop-up window to be displayed and the profile settings button 542D may cause a new window for entering personal information, changing a password and linking accounts, among other profile and/or settings tasks.

When a button is referred to as causing display of information, the button may cause the information to be displayed in response to being clicked (or touched, selected or otherwise interacted with).

The overview sub-screen 520B-1 may also include a salutation 544, a best opportunities portion 546, a top college portion 547 and a more options display portion 548. The salutation 544 may include the logged in user's name and a greeting (e.g., “Hello Kyle” and “Welcome back!”), the best opportunities portion 546 may include a graphic image (e.g., of two students outside of a college), a number of colleges analyzed (e.g., 23 colleges out of 6,810) and a recommended colleges button 546A. When the recommended colleges button 546A is clicked on, a new sub-screen may be displayed in the same area as portion 520B and the new sub-screen may display top colleges (e.g., the three highest ranked colleges). This new sub-screen may correspond to the top three colleges 562, 564 and 565 (discussed in more detail below).

The top college portion 547 may display the highest ranked college for the logged in user (e.g., the user whose name is displayed in salutation 544) and a personalized ranking score (e.g., shown as 84%, which corresponds to a match percentage).

The more options display portion 548 may include an indication 548A of the number of additional colleges (e.g., 20) that could be recommended if circumstances were different (e.g., different financial information) and a view all button 548B. The view all button 548B may cause an excluded colleges page to be displayed. The excluded colleges page may include a ranked list of colleges that would be included but were not included because the financial cost of attendance was above the threshold budget.

FIG. 5C shows an example of an excluded colleges display area or screen 520B-1A. The excluded colleges display screen 520B-1A includes the survey toggle button 542A, the start survey button 542B and an excluded colleges display area 589. The excluded colleges display area 589 displays other colleges (e.g., 590-599) that may be considered (could be recommended) but are not because of a student's specific survey response (i.e. an “Excluded Colleges” page). Each of the colleges 590-599 may include a personalized ranking (e.g., a bar graph indicating a ranking value between 10-100 or 0-100, and the actual ranking value (e.g., 100), and the reason for exclusion (e.g., “Finance”). The row corresponding to the colleges may also include one-click financial reduction strategies buttons 591A, 591B, 591C and 591D. Although shown and labeled for college 591, colleges 592 and 593 also show one-click financial reduction strategies buttons. The one-click financial reduction strategies buttons may correspond to financial reduction strategies discussed herein and include the same functionality but be immediately applied (the one-click on the buttons 591A-591D are automatically applied without an additional click on an apply button). The one-click financial reduction strategies buttons may include an indication of the type of strategy via an icon and may display a description of the type of strategy when hovered over. For example, button 591A may include tools corresponding to Strategy #1 “Work in College”, button 591B may include an icon of a school to correspond to Strategy #2 “Community College” strategy, button 591C may include an icon of a timer to correspond to Strategy #3 accelerated graduation (e.g., graduate in under four years), and button 591D may include an icon representing a school and a tool to correspond to Strategy #4 (Work and Community college). When the relevant button 591A-591D is clicked on, the relevant strategy may be automatically applied as discussed herein. Each of the excluded colleges 590-599 may include the one-click buttons 591A-591D (although FIG. 5C only shows the buttons for colleges 591-593).

The exclusions column of each college 590-599 includes an insight into why the college was excluded or received a low ranking. The strategy column of each college 590-599 includes the one-click buttons (e.g., 591A-591D), which are enabled to cause any of the strategies to be applied. Once a strategy is applied, the college can be ranked and recommended. When the icons are clicked on to apply the strategy, the user may return to the Dashboard. If there are no icons in the Strategy column (e.g., for Colleges 590 and 594-599), the college cannot be recommended even by applying a strategy. To find a way to make that college recommended, the info provided in the Exclusions column may help make adjustments to the survey answers.

The overview sub-screen 520B-1 may also include a top colleges display area 560. The top colleges display area 560 may include a ranked list of colleges 562-568. The ranked list of colleges 562-568 are ranked based on three categories: finance, academic and fit (non-finance and non-academic preferences). Each of the ranked colleges may include the same graphical indicators. For illustrative purposes, ranked college 562 is discussed in detail but the same graphical indicators are shown (and are applicable) for the remaining ranked colleges 564-568.

Ranked college 562 may include a name of the college 562A (e.g., “Pennsylvania State University-Penn State Erie-Behrend College”), personalized ranking information 562B (e.g., a line graph showing 84% and a numerical ranking of 84), a personalized admission percentage 562C (e.g., 99%), a ranked category 562D (e.g., No. 1 Safety), and an application recommendation 562E (e.g., “Yes, apply”). The personalized ranking information 562B showing 84 or 84% may correspond to an overall ranking in FIG. 5A. The admission percentage 562C may correspond to a likelihood of admittance based on comparing the academic quality information of the target student (e.g., “Kyle”) corresponding to the logged in user's user profile with the academic quality information of the respective university/college corresponding to the name (e.g., 562). The academic quality information may include one or more of: a grade point average (GPA), class rank, demographic information (e.g. athlete, socio-economics, location), a standardized test score, or a combination of the GPA, class rank, demographic information, and standardized test score. For example, the admission percentage 562C may correspond to a percentile score (or centile) or probability (likelihood) that the target user (e.g., Kyle) will be accepted for admission, which may mean where the admission percentage is 99% that the user has a 99% chance of gaining admittance or 99 out of every 100 candidate student applicants having the same academic quality information are admitted to that respective named school.

Potential considerations include evaluating colleges on the following criteria:
1. Student/Faculty ratio
2. Percent of full-time faculty
3. Number of research programs/opportunities offered
4. Student retention rate
5. Student graduation rate

Other potential considerations for evaluating academic quality of a college may include one or more of: Graduation rates, First-year retention rates, Graduation rate performance, Pell graduation rates, Pell graduation performance, First generation graduation rates, First generation graduation rate performance, Borrower debt, College grads earning more than a high school grad, Peer assessment, Faculty salaries, Student-faculty ratio, Full-time faculty, Financial resources per student, Standardized tests, Citations per publication, Field weighted citation impact, Publications cited in threshold percentage (e.g., top 5%) of journals, Publications cited in threshold percentage (e.g., top 25%) of journals, Class size, Terminal degree faculty, Alumni giving average, Graduate debt proportion borrowing and/or High school class standing.

564C shows personalized admission percentage for named school 564. 564D and 565D show a ranked category (“No. 2 Safety” and “No. 1 Match”, respectively) that are different from ranked category 562D (“No. 1 Safety”). The ranked categories may include a preset number of ranked categories (e.g., three of each type of category). The ranked categories may include three types of categories (e.g., Safety, Match and Reach). A Reach type category may correspond to less than a first threshold (e.g., 30%) chance of admittance and a Safety type category may correspond to greater than a second threshold (e.g., 70%) chance (or probability/likelihood of admittance). A Match category may correspond to a chance (or probability/likelihood) of admittance that is between the first threshold and the second threshold.

Each of the rows corresponding to a recommended school may include a recommendation 562E, 567E. For example, recommendation 562E indicates that a logged in user (e.g., Kyle) should apply (“Yes, apply”). In contrast, recommendation 567E indicates that some changes to the survey data may be needed prior to the user applying to that school.

As shown in FIG. 5A, top colleges display area 560 may also include a Ranking Details display portion/area including schools 582 and 584. Schools 582 and 584 may correspond to schools 562 and 564, respectively. Although only two schools are shown in the Ranking Details display portion more schools may be displayed (e.g., corresponding to schools 562-568). School name 582A may correspond to the name of the ranked school (e.g., corresponding to ranked school 582). Academic meter 582B may show filled in containers (e.g., curved rectangular containers) that illustrate an academic ranking of the school 582. For example, academic meter 582B may have containers more filled (e.g., approximately 3 and a half containers filled in) than academic meter 584B (three containers filled in). Likewise, finance meter 582C may show an indication of the financial ranking of the respective school 582. Fit (or preference) meter 582D shows a meter indicating a fit (or preference) ranking of the school 582.

Overlapping elements are not repeated and may correspond to previously described elements having a same or similar name (e.g., a new instance of a GUI button in a subsequent FIG. may correspond to the previous description of the same button). While explaining the GUIs according to embodiments of the disclosure, a detailed description of the contents overlapping with the GUIs according to the embodiments will be omitted.

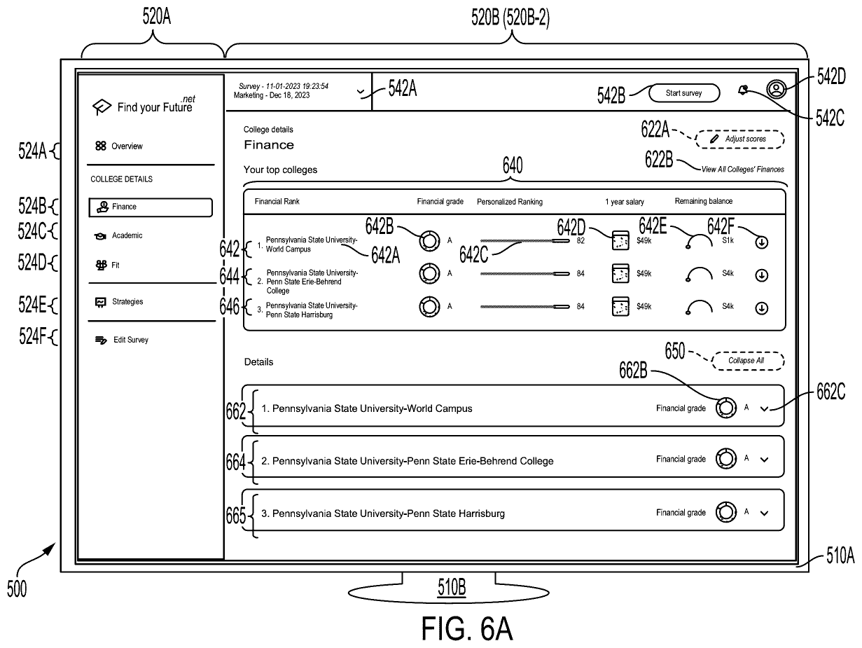

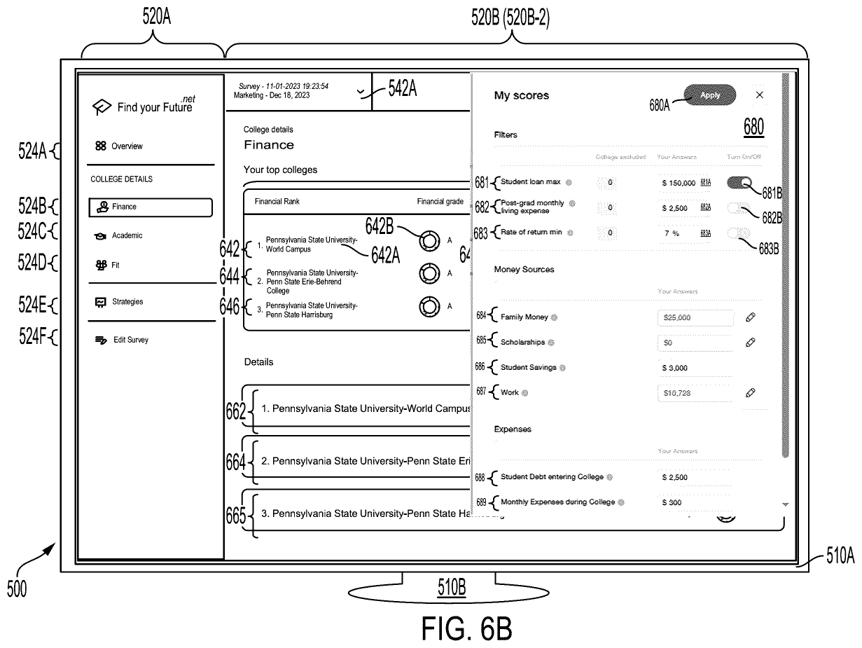

FIG. 6A illustrates the electronic display 500 with modifications to the GUI including modifications to the vertically-extending menu bar column portion 520A, and dynamic display area 520B (showing finance sub-screen 520B-2).

The menu bar portion 520A of FIG. 6A includes a boundary box surrounding the currently selected button (which is the currently selected Finance button 524B in FIG. 6A). When the Finance button is currently selected as shown in FIG. 6A, the dynamic display area 520B displays a finance GUI 520B-2.

The finance sub-screen 520B-2 may include a survey toggle box 542A, a start new survey button 542B, a notifications bell button 542C and a profile settings button 542D, as discussed above. The overview sub-screen 540B-1 may also include an adjust scores button 622A and a view all colleges' finances button 622B.

The adjust scores button 622A, when clicked, may cause a my scores GUI 680 (shown in FIG. 6B), which may be an overlay (or pop-up window), to be displayed. The my scores overlay 680 may include an apply button 680A and user entry fields that allow a user to enter various filters, money sources and expenses. For example, the my scores overlay 680 may include a student loan max filter entry field 681A, a post-grad monthly expense filter field 682A, and a rate of return minimum filter entry field 683A.

The student loan max field 681A may correspond to the total maximum amount of student loans a student is willing to accept as part of graduating from college. Graduating with excessive student loans will significantly limit students' job opportunities and living options. Any college with a “Remaining Balance” in excess of this amount will be excluded from recommended colleges. $50,000 may be used as a default for the student loan max field and the user may adjust this amount.

The post-grad monthly living expense 682A may correspond to the total monthly amount of expenses a student will likely incur after graduation. This number helps determine whether students can afford basic living necessities upon graduation. Depending on circumstances (e.g., high cost of living areas), monthly living expenses for students after graduation frequently fall within $2,000 to $4,500. $2,500 may be used as a default. Any college with a projected salary less than a student's monthly living expenses will be excluded from recommended colleges.

The rate of return min 683A may correspond to the percentage gain or loss as measured by a college's total cost against a college's total projected lifetime earnings or a student's lifetime earnings as a graduate having the specified degree against expected lifetime earnings of a person who does not attend college. This number helps determine whether students are getting a good financial deal. People often consider a Rate of Return/Investment (ROI) of 7%-10% as a good investment, and anything over 10% as a really good investment. As a default, 7% may be used for the rate of return min field. Any college with an ROI that is less than the ROI minimum will be excluded from recommended colleges.

Each of the filters 681-683 include a text box or numerical entry field 681A-683A for accepting a monetary value or percentage, respectively. Additionally, each of the filters 681 may include an associated toggle button 681B-683B for turning the associated filter on/off. The toggle on/off buttons may indicate whether the filter is on or off. For example, 681B has a different color than buttons 682B, 683B and has a circular indicator on the right side of the button compared to on the left side of the button in buttons 682B, 683B. The buttons 682B, 683B may be greyed out and the active filter button 681B may be blue.

The my scores GUI 680 may also include money sources 684-687 (including description and user-input fields) and expenses 688, 689 (including description and fields). The money sources 684-687 may include respective fields for entering family money 684, scholarships 685, student savings 686 and work 687. The expenses fields may include a student debt entering college field 688 and a monthly expense during college field 689.

The calculating the expected lifetime earnings corresponding to the specified degree may include projecting earnings over a career based on the expected salary (e.g., a first-year salary, or mid-career salary) of the specified degree and an expected salary increase (e.g., flat annual salary increase, an inflation adjusted annual salary increase) during the career. For example, the flat salary increase may be 5% or 8% with or without adjustment for inflation. The “over a career” may correspond to an average number of years of a career of a person corresponding to the user profile. For example, a profile of a woman may have a different average number of years of a career compared to a profile of a man.

The finance sub-screen 520B-2 may also include a top colleges display area 640. The top colleges display area 640 may include a ranked list of colleges 642-646. The ranked list of colleges 642-646 are ranked based on financial factors (based on financial factors for the logged in user (e.g., the user whose name is displayed in salutation 544 and based on the survey 542A)). Each of the ranked colleges 642-646 may include the same graphical indicators. For illustrative purposes, ranked college 642 is discussed in detail but the same graphical indicators are shown (and are applicable) for the remaining ranked colleges 644 and 646.

Ranked college 642 may include a name of the college 642A, a financial grade indicator 642B (e.g., a donut shaped icon that is filled to a percentage corresponding to a grade and/or a letter grade (e.g., shown as ‘A’)), a personalized ranking 642C, a first year salary 642D, a remaining balance 642E and an expander button 642F. The financial grade of the financial grade indicator 642B may be based on a financial calculation and/or a financial ranking. The personalized ranking 642C may be based on the overview ranking (i.e., all three factors/categories). The first year salary 642D may be based on sourced data (e.g., from the Department of Education servers) that indicate the expected or average first year salary for the selected major. The remaining balance 642E may correspond to a calculation of how much of the remaining cost of attendance is remaining after a student's (and/or a student's associates) contributions are considered.

The finance sub-screen 520B-2 may include a collapse all button 650 which causes the individual sub-screens for schools 662-665, when clicked, causes each of the details screens of the schools to be hidden. The expander button performs the same function as 662C for the relative school (e.g., the school on the same row). The details area of the sub-screen 540B-1 may include a plurality of schools (three are shown, schools 662-665) and each may include a financial grade 662B and a collapse/uncollapse button 662C. When uncollapsed, each individual school may display additional information such as the total cost of college (e.g., $67K), a financial breakdown (e.g., Tuition (62%): $41 k, Room and Board (34%): $23 k and Books and Supplies (4%): $5 k), payments (e.g., remaining balance (2%): $1 k, Total payments: $71 k, Scholarships (0%): $0K, Parent Money (75%): $50K, Student Money (0%): $0K, Work (31%): $21 k), Strategy #2 (e.g., 2 years at community college) and Earnings (e.g., $3.7M Lifetime earnings, $398 k College premium, 7.5% ROI, Cash at Graduation $0 k, First year salary $49 k and mid-career salary $88 k).

The Total College Cost may be calculated as the total estimated cost as a result of graduating from the applicable college before subtracting one or more of: scholarship(s) or family money contribution(s). The tuition amount may be calculated as the total estimated cost charged by the applicable college over four years, unless a different time period is specified. Room and Board amount may be calculated as the total estimated cost charged by the applicable college for lodging and food over four years, unless a different time period is specified. Books and Supplies cost may be calculated as the total estimated cost charged by one or more of: the applicable college for textbooks, supplies, and equipment over four years, unless a different time period is specified.

Your Final Cost (Remaining Balance) may be calculated as the total estimated cost owed by the student after all other payments have been applied to the total college cost. Many students borrow this amount through student loans, but many other options exist.

College Scholarships amount may be calculated as follows: the total money applicable to the student's college education as a result of one or more of the applicable college's scholarship(s) or grant(s) (including merit-based and needs-based scholarships).

Family Money contribution amount may be calculated as the total money applicable to the student's college education as a result of money provided by the student's family (including from the student's parents or grandparents or guardians).

Work amount may be calculated as the total money applicable to the student's college education as a result of the student working and applying the wages earned to the college cost. Student Money amounts may be calculated as follows: the total money applicable to the student's college education as a result of money paid by the student, frequently through the student's own savings or investments.

Lifetime Earning amount may be calculated as the student's total estimated earnings accrued from graduation through the typical retirement age.

College Premium may be calculated as the additional average wage estimated and payable to the student as a result of graduating from the applicable college.

ROI (Return on Investment) may be calculated as the estimated college premium relative to the total cost of college.

Cash at Graduation amount may be calculated as follows: the total amount of money that the student is estimated to have at college graduation.

1-year Salary may be calculated as the student's estimated salary one year from graduation as a result of graduating from the applicable college with the applicable major. Mid-career Salary may be calculated as the student's estimated salary ten years from graduation as a result of graduating from the applicable college with the applicable major.

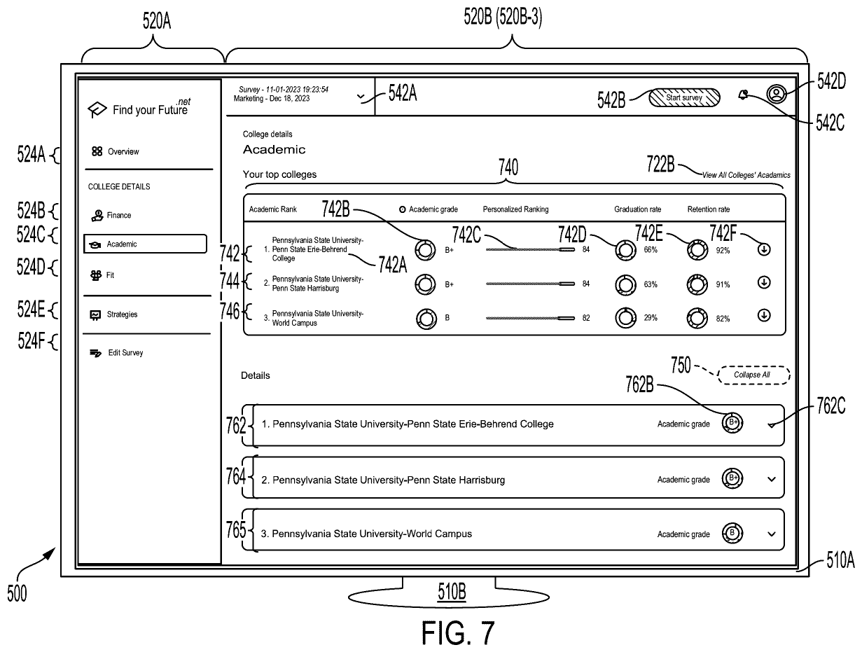

FIG. 7 illustrates an electronic display 500 with modifications to the GUI including modifications to the vertically-extending menu bar column portion 520A, and dynamic display area 520B (showing academic sub-screen 520B-3).

The menu bar portion 520A of FIG. 7 includes a boundary box surrounding the currently selected button (which is the currently selected Academic button 524C in FIG. 7). When the Academic button is currently selected as shown in FIG. 7, the dynamic display area 520B displays an academic GUI 520B-3.

The academic sub-screen 520B-3 may include a survey toggle box 542A, a start new survey button 542B, a notifications bell button 542C and a profile settings button 542D, as discussed above.

The academic sub-screen 520B-3 may also include a top colleges display area 740. The top colleges display area 740 may include a ranked list of colleges 742-746. The ranked list of colleges 742-746 are ranked based on academic factors (based on academic factors for the logged in user (e.g., the user whose name is displayed in salutation 544 and based on the survey 542A)). Each of the ranked colleges 742-746 may include the same graphical indicators. For illustrative purposes, ranked college 742 is discussed in detail but the same graphical indicators are shown (and are applicable) for the remaining ranked colleges 744 and 746.

Ranked college 742 may include a name of the college 742A, an academic grade indicator 742B (e.g., a donut shaped icon that is filled to a percentage corresponding to a grade and/or a letter grade (e.g., shown as ‘B+’)), a personalized ranking 742C, a graduation rate 742D, a retention rate 742F and an expander button 742F. The academic grade of the academic grade indicator 742B may be based on an academic calculation and/or an academic ranking. The personalized ranking 742C may be based on the overview ranking (i.e., all three factors/categories). The graduation rate 742E and retention rate 742F may be based on aggregated data and may correspond to a graduation/retention rate for the school and/or for the school and the major.

The academic sub-screen 520B-3 may include a collapse all button 750 which causes the individual sub-screens for schools 762-765, when clicked, causes each of the details screens of the schools to be hidden. The expander button performs the same function as 762C for the relative school (e.g., the school on the same row). The details area of the sub-screen 520B-3 may include a plurality of schools (three are shown, schools 762-765) and each may include an academic grade (e.g., 762B) and a collapse/uncollapse button (e.g., 762C). When uncollapsed, each individual school may display additional academic information such as the full-time faculty percentage (e.g., 81%), a percentage of graduates in the survey major (e.g., 5.62%), a graduation rate (66%), a retention rate (e.g., 92%), student/faculty ratio (17:1), and number of research programs/opportunities offered (220).

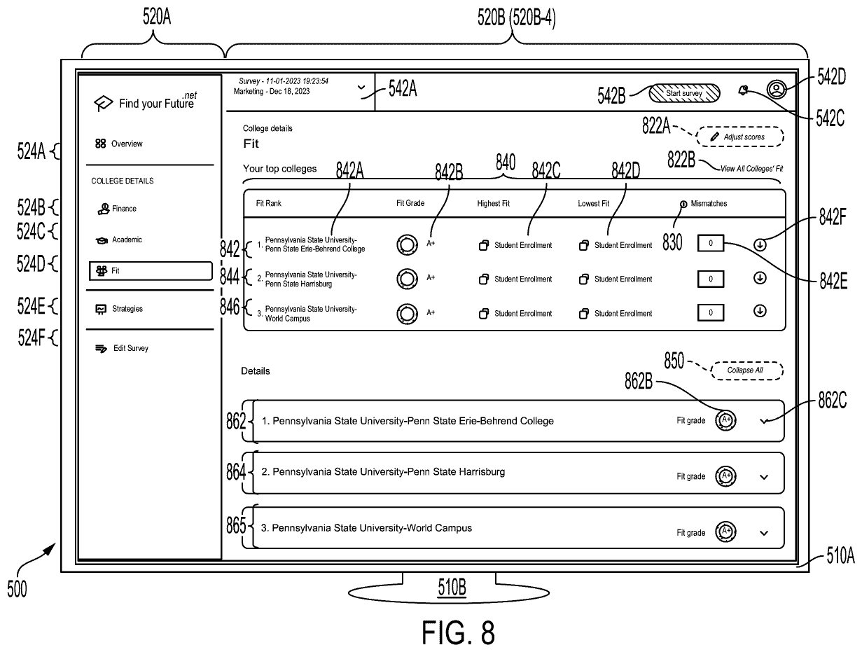

FIG. 8 illustrates an electronic display 500 with modifications to the GUI including modifications to the vertically-extending menu bar column portion 520A, and dynamic display area 520B (showing fit sub-screen 520B-4).

The menu bar portion 520A of FIG. 8 includes a boundary box surrounding the currently selected button (which is the currently selected fit button 524D in FIG. 8). When the fit button is currently selected as shown in FIG. 8, the dynamic display area 520B displays a fit GUI 520B-4.

The fit sub-screen 520B-4 may include a survey toggle box 542A, a start new survey button 542B, a notifications bell button 542C and a profile settings button 542D, as discussed above.

The fit sub-screen 520B-4 may also include a top colleges display area 840. The top colleges display area 840 may include a ranked list of colleges 842-846. The ranked list of colleges 842-846 are ranked based on fit factors (based on fit factors for the logged in user (e.g., the user whose name is displayed in salutation 544 and based on the survey 542A)). The fit factors may be factors that are preferences related to the school that are not categorized as academic or financial.

Each of the ranked colleges 842-846 may include the same graphical indicators. For illustrative purposes, ranked college 842 is discussed in detail but the same graphical indicators are shown (and are applicable) for the remaining ranked colleges 844 and 846.

Ranked college 842 may include a name of the college 842A, a fit grade indicator 842B (e.g., a donut shaped icon that is filled to a percentage corresponding to a grade and/or a letter grade (e.g., shown as ‘A+’)), a highest fit 842C, a lowest fit 842D, a mismatches value 842E and an expander button 842F. The fit grade of the fit grade indicator 842B may be based on a fit calculation and/or a fit ranking. The highest fit 842C may show a fit category having the greatest match (e.g., student enrollment) between the survey user preferences and the school's attributes and the lowest fit 842D may show a fit category having the lowest match/correlation between the survey user preferences and the school's attributes. The mismatches box 842E shows important mismatches, such as factors that are not a match and are indicated as above a threshold level of importance (e.g., “very important”) by the student (e.g., in the survey data).

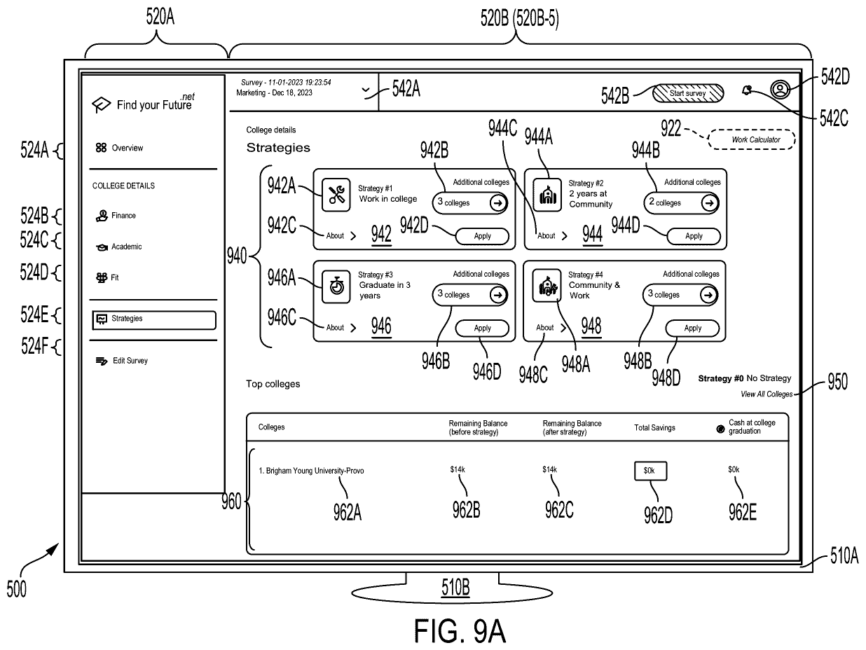

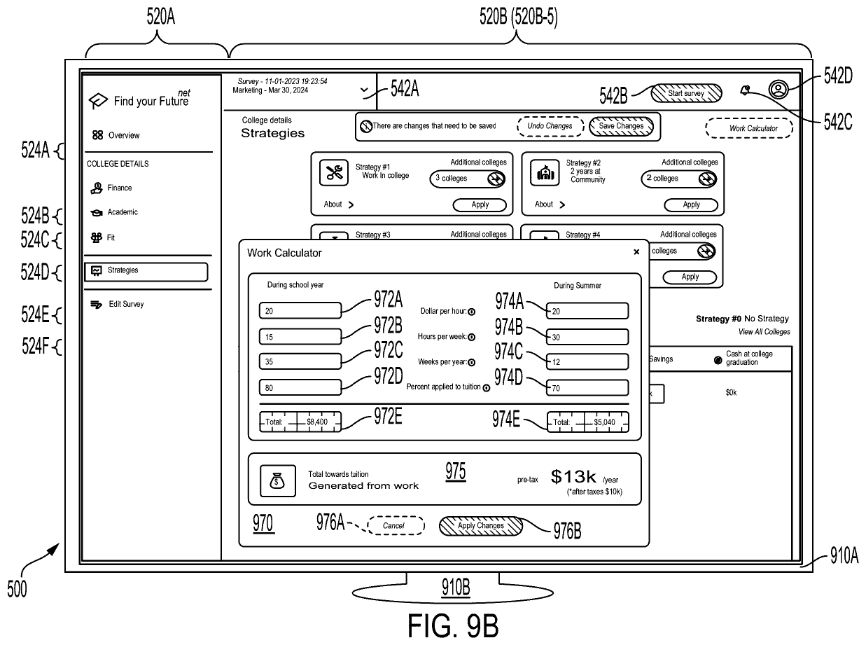

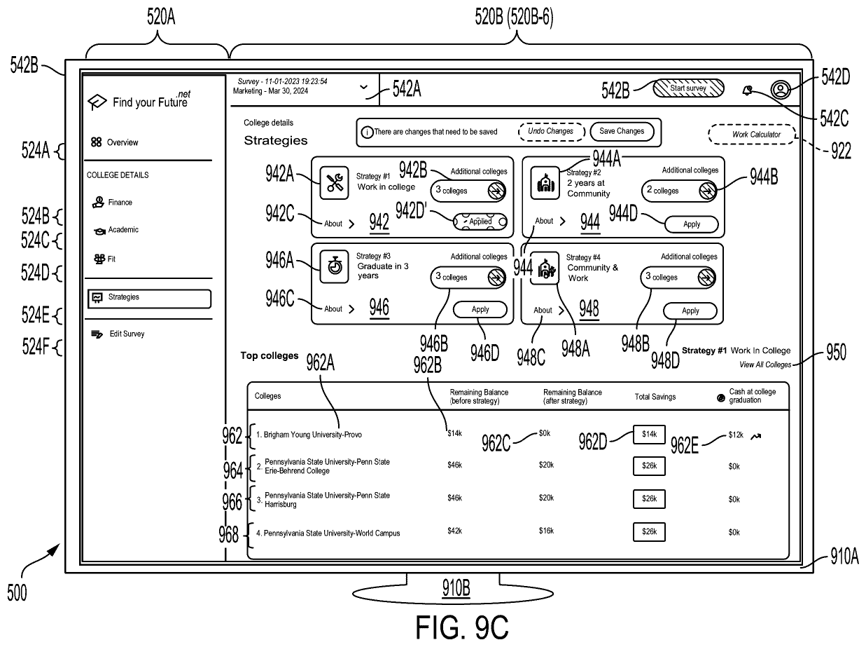

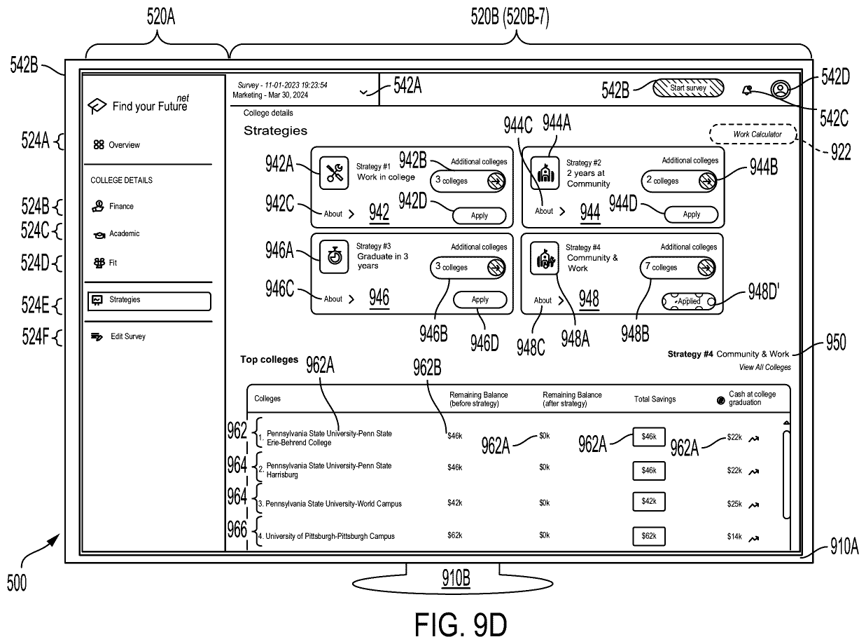

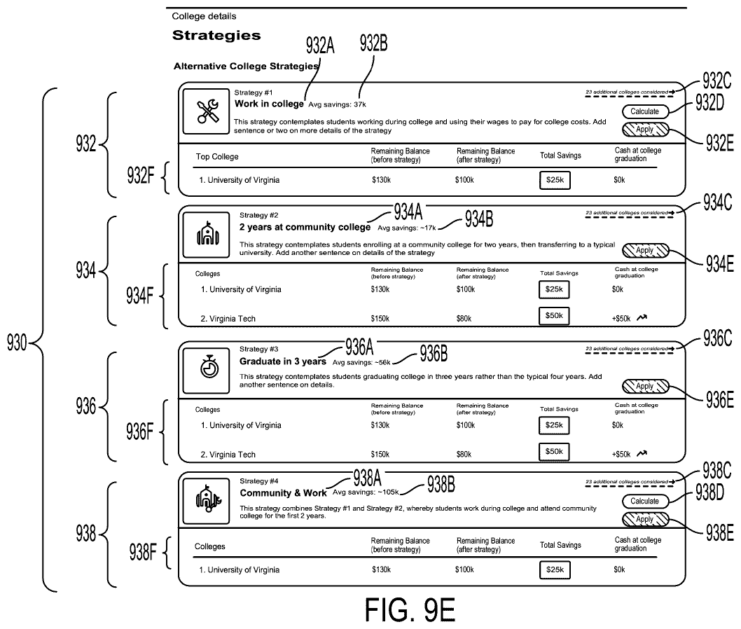

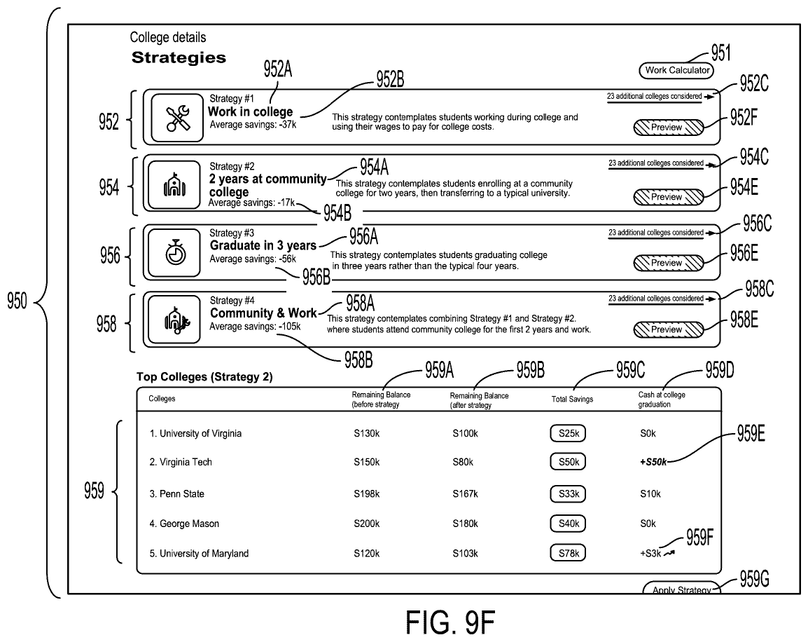

FIG. 9 illustrates an electronic display 500 with modifications to the GUI including modifications to the vertically-extending menu bar column portion 520A, and dynamic display area 520B (showing fit sub-screen 520B-5).

The menu bar portion 520A of FIG. 9 includes a boundary box surrounding the currently selected button (which is the currently selected strategies button 524E in FIG. 9). When the strategies button is currently selected as shown in FIG. 9, the dynamic display area 520B displays a strategies GUI sub-screen 520B-5.

The strategies sub-screen 520B-5 may include a survey toggle box 542A, a start new survey button 542B, a notifications bell button 542C and a profile settings button 542D, as discussed above.

The strategies sub-screen 520B-5 may also include a work calculator button 922 and a strategies display area 940 including a plurality of strategies sub-display boxes/areas 942, 944, 946 and 948. When the work calculator button 922 is depressed, the work calculator GUI 970 (in FIG. 9B) may be displayed.

Each of the sub-display boxes/areas may include a type of strategy (942A, 944A, 946A, 948A), an additional colleges button (942B, 944B, 946B, 948B), an about button (942C, 944C, 946, 948C) and an apply button (942D, 944D, 946D, 948D).

The selectable optional financial reduction strategies buttons may include one or more of the following strategies: a work in college strategy, spending two years at a community college strategy, a graduate within three years strategy, a scholarship strategy, a pre-college credits strategy, a college money saving activities strategy, or a college money generating activities strategy. As shown in FIG. 9, the displayed type of strategy may be a Work in College strategy 942A, a 2 years at Community College strategy 944A, a Graduate in 3 years strategy 946A or a Community College and Work strategy 948A. The additional colleges button(s) indicate the number of additional colleges that will qualify (e.g., based on a threshold budget) when the relevant strategy is applied. For example, FIG. 9A shows a sub-screen 520B-5 before any apply buttons have been selected/activated, and FIG. 9C shows a sub-screen 520B-6 after the apply button 942D has been activated.

The selectable optional financial reduction strategies buttons may include one or more of the following strategies: a work in college strategy, a work-study program strategy, a paid internship strategy, a paid externship strategy, a residential assistant strategy, a federal scholarship strategy, a state scholarship strategy, a private grant strategy, an Advanced Placement credit strategy, a College Level Examination Program strategy, an International Baccalaureate strategy, a dual enrollment strategy, a summer classes strategy, a military program strategy, a Reserve Officers' Training Corps (ROTC) strategy, a living at home strategy, a reducing room and board expense strategy, a community college strategy (e.g., a spending two years at a community college strategy), an accelerated graduation strategy (e.g., a graduate in less than four years (e.g., within three years) strategy), a scholarship strategy, a pre-college credits strategy, a college money generating activities strategy, attending an out-of-state college with reciprocity strategy, or an attaining in-state residency strategy.

In FIG. 9A, the top colleges area 960 shows one school but in the same area of FIG. 9C, three additional colleges are shown 964, 966 and 968. When one of the apply buttons (942D, 944D, 946D, 948D) are clicked, the strategy type (e.g., 942A, 944A, 946A or 948A) is applied such that the number of colleges that meet the threshold budget criteria is adjusted. For example, as shown in comparing FIGS. 9A and 9C, three additional colleges are added after the Work in College strategy is applied (by clicking apply button 942D). The apply button 942D also changes between FIGS. 9A and 9C to show that the apply button 942D′ is now distinguished to indicate activation (the distinguishment may be a background design, a different color, a bolding, hatching or a combination thereof). The top colleges area 960 may include one or more schools on each row. For example, 962 includes a college name 962A (e.g., Brigham Young University-Provo), a remaining balance (before strategy) 962B (e.g., $14K), a remaining balance (after strategy) 962C (e.g., $0K),

The strategies sub-screen 520B-5 may also include a view all colleges button/hyperlink 950 (the “View All Colleges” text may be a hyperlink). The view all colleges button 950 may cause a new overlay screen to display that focuses on the colleges that are now available based on the strategy (e.g., the additional colleges 962, 964, 966, 988) after the Work in College Strategy is applied.

The work calculator GUI 970 (in FIG. 9B) may be displayed in response to work calculator button 922 being clicked. The work calculator GUI 970 may include two columns in an upper portion including a “during school year” column and a “during summer” column. Each of the columns may include a dollar(s) per hour input field (972A, 974A), an hours per week field (972B, 974B), a weeks per year field (972C, 974C), and a percent applied to tuition field (972D, 974D). At the bottom of the respective columns, a calculated total (972E, 974E) may be displayed. In addition, a total towards tuition display area 975 may show an expected total pre-tax amount per year (e.g., $13K is shown in 970 of FIG. 9B).

The work calculator GUI 970 may also include an apply (save) changes button 976B and a cancel changes button 976A. The apply changes button 976A saves the data involved in the calculation (i.e., 972A-972D, 972E, 974A-974D, 974E) in the database in association with the user's profile and adjusts the student's threshold budget.

FIG. 9D shows GUI 520B-7 and is similar to FIGS. 9A and 9C but with the Community and Work (948) apply button 948D′ activated and distinguished (e.g., via a unique background design). In addition, the view all colleges button 950 indicates the Community & Work strategy is applicable/applied in FIG. 9D. When a different strategy is applied, the Top Colleges displayed (962-966) are different (the Top Colleges in FIG. 9C are different from the Top Colleges in FIG. 9D).

FIGS. 9E and 9F show different variations of the strategies display area 940 (in FIGS. 9E and 9F the strategies display area is indicated as 930 and 950, respectively).

In FIG. 9E, the strategies display area 930 includes a plurality of strategies sub-display boxes/areas 932, 934, 936 and 938 displayed one on top of the other. Each of the sub-display boxes/areas may include a type of strategy (932A, 934A, 936A, 938A), an amount of average savings (932B, 934B, 936B, 938B), an additional colleges button (932C, 934C, 936C, 938C), an apply button (932E, 934E, 936E, 938E), and strategy-specific top colleges area (932F, 934F, 936F, 938F). The strategy-specific top colleges area(s) are similar to the top colleges area(s) (ranked based on finance) described above (i.e., a financial ranking) but include on the basis of the respective strategy having been applied. Instead of an about button, the description used in the about button is displayed in the strategies sub-display boxes/areas 932-938 (e.g., “This strategy contemplates . . . ”). In addition, the Work in College strategies sub-display box/area 932 and the Community and Work strategy sub-display box/area 938 include a work calculator button 932D, 938D.

In FIG. 9F, the strategies display area 950 includes a plurality of strategies sub-display boxes/areas 952, 954, 956 and 958 displayed one on top of the other. Each of the sub-display boxes/areas may include a type of strategy (952A, 954A, 956A, 958A), an amount of average savings (952B, 954B, 956B, 958B), an additional colleges button (952C, 954C, 956C, 958C), and a preview button (952F, 954E, 956E, 958E). When one of the preview buttons is selected/clicked, a strategy-specific top colleges area 959, displays strategy-specific top colleges area(s) similar to the top colleges area(s) (ranked based on finance) described above (i.e., a financial ranking) but include on the basis of the respective strategy having been applied/previewed. Instead of an about button, the description used in the about button is displayed in the strategies sub-display boxes/areas 952-958 (e.g., “This strategy contemplates . . . ”). In addition, the work calculator is provided as work calculator button 951. The strategies display area 959G also includes an apply/save strategy button 959G, which applies/saves the previewed strategy. Note: One or more strategies may be previewed/applied/saved.

### Survey Data

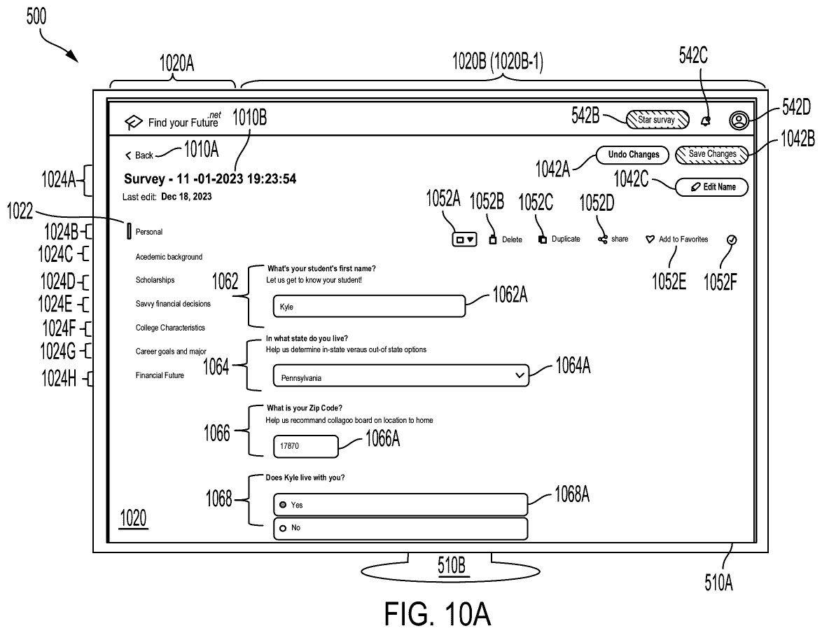

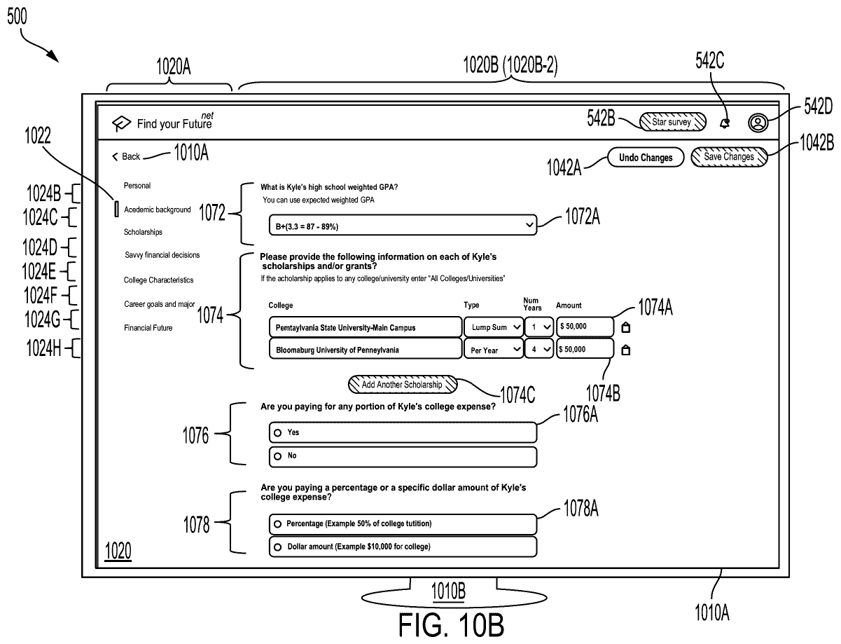

FIGS. 10A and 10B show examples of input screens for a user to input student profile data. The point of FIGS. 10A and 10B is to show the different types of user input fields that may be used when conducting a student profile survey to collect survey data, but many different types of user input fields may be used. The survey input screens may be displayed when the start survey button (e.g., 542B) or the edit survey button 524F is clicked (with the edit survey button, data that has already been entered may be shown in the fields for editing, while the start survey button may include a blank survey). The drop-down and edit survey are part of the real time updates.

The GUI 1020 may be a nested GUI and may include a vertically-extending menu bar column 1020A, and a dynamic display area 1020B.

The menu bar portion 1020A may include a company logo (shown as “Find your Future.net”), and interactable hyperlinked buttons 1024A-1024H. The interactable buttons 1024A-1024H may be buttons (e.g., text or icon buttons) and cause the dynamic display area 1020B to display certain types of information and/or different GUIs (or sub-screens) based on (e.g., in response to) user interaction with the button (e.g., when the button is activated).

The buttons may be hyperlinked to other webpages/GUI screens or sub-screens and transition between webpage/GUI screens or sub-screens within a respective application/website. For example, when button 1024A is clicked on, the survey sub-screen (or display portion) 1020B-1 of FIG. 10A may be displayed.

The menu bar portion 1020A may include a back button 1010A, a survey date/timestamp, including a last edit date, and a plurality of survey menu buttons 1024B-1024H. The survey menu buttons may correspond to different types of survey questions that may be asked (prompted for). The survey buttons may include personal 1024B, academic background 1024, scholarships 1024D, savvy financial decisions 1024E, college characteristics 1024F, career goals and major 1024G and financial future 1024H.

The menu bar portion 1020A may include a rectangular indictor 1022 adjacent to the currently selected button (which is 1024B in FIG. 10A) for indicating which section of the survey is currently being displayed. For example, in FIG. 10A, the display area 1020B-1 is displaying questions 1062-1068 related to personal information. Each of the questions 1062-1068 may include one or more input fields 1062A-1068A. The input fields may be text input fields (1062A), a drop down menu (1064A), a numerical only input field 1066A (which may be constrained to only accept the correct type of information asked for, such as a zip code (e.g., five numerical digits)) or toggleable radio buttons 1068A. The input fields 1062A-1068A receive survey data input by a user which is then saved in the database in association with the user's survey when the save changes button 1042B is clicked (or interacted with).

The survey sub-screen (or display portion) 1020B-1 may also include an undo changes button 1042A, a color coded mode selector 1052A, a delete button 1052B, a duplicate survey button 1052, a social media share button 1052D, an add to favorites button 1052E and a status indicator 1052F.

FIG. 10B is similar to FIG. 10A but now the end of the academic background section of the survey and the beginning of the scholarship section of the survey is being displayed in display area 1020B-2 with survey questions 1072-1078.

### Survey Questions

The survey questions may include displaying the following questions (and user input field type) in the survey display area 1020B, when the specified button is clicked/selected:

The “Personal” button and corresponding display area: (1) “What is the student's first name?” (text entry box, which may be “Kyle”), (2) “In what state does the student live?” (drop-down menu of U.S. states), (3) “What is the student's Zip Code?” (text entry field, which may require U.S. Zip Code format), and (4) “What will the student's age be at college graduation?” (text entry field, which may require a numerical value).

The “Academic Background” button and corresponding display area: (5) “Has Kyle taken or planning to take the SAT?” (Yes/No radio buttons), (6) “Has Kyle taken or planning to take the ACT?” (Yes/No radio buttons), (8) “What is Kyle's high school class rank?” (drop down menu of various thresholds, such as Top 1%, Top 5%, Top 10%, Top 25%, Top 50% and outside Top 50%), and (9) “What is Kyle's high school weighted GPA?” (drop-down menu of A+, A, A−, B+, B, B−, C+, C, C−, D+ and Below D+).

When Question (5) is Yes, additional Questions (5A) and (5B) may include “What is Kyle's SAT Math Score?” (text input field) and “What is Kyle's SAT Reading and Writing Score?” (text input field), respectively.

When Question (6) is yes, additional questions (6A), (6B) and (6C) may be include: “What is Kyle's ACT math score?” (text input field), “What is Kyle's ACT reading score?” (text input field) and “What is Kyle's ACT writing score?” (text input field), respectively.

When both Question (5) and Question (6) are No, Questions (7A) and (7B) may be automatically populated for display and include “What is Kyle's PSAT math score?” (text input field) and “What is Kyle's PSAT reading score?” (text input field), respectively.

Question (9) corresponds to Question 1072 in FIG. 10B including the corresponding input field 1072A which is a drop-down menu.

The “Scholarships” button 10224D and corresponding display area: may include a Question (10) “Please provide the following information on each of Kyle's scholarships and/or grants.” (with multiple input fields). Question 1074 of FIG. 10B corresponds to Question (10) and includes multiple input fields 1074A and 1074B, which each include four parts (a college name text input field, a type of scholarship drop-down menu field, a number of years drop-down menu field and an amount menu field). In addition, additional menu fields like 1074A, 1074B may be added by clicking on the add another scholarship button 1074C.

The “Savvy financial decisions” button 1024E and corresponding display area: Question (11) “Are you paying for any portion of Kyle's college expense?” (includes any money contributed, including from 529 Plans, military benefits, and other gifts) (Yes/No toggle radio buttons), Question (12A) “Are you paying a percentage or a specific dollar amount of Kyle's college expense (Percentage/Dollar Amount Radio button), Question (12B) “What is the percentage?” (text field for entering a percentage), (12C) “What is the dollar amount?” (text field for entering a numerical value), (13A) “Will Kyle use money from their personal savings to pay for college?” (Yes/No radio button), (14A) “Will Kyle have any debt upon entering college?” (Yes/No radio button), and (15) “At college, what will be Kyle's ordinary living expenses, on average, per month? Including coffee, streaming services, but not including rent, textbooks, on-campus meal plans” (numerical input field).

The input fields 1076A and 1078A of FIG. 10B are each toggleable radio button input fields and correspond to Questions (11) and (12A), respectively.

Question (12B) is only displayed when Question (12A) corresponds to the percentage radio button being selected, and Question (12C) is only displayed when Question (12A) corresponds to the dollar amount radio button being selected. If the Yes/No radio button of Question (13A) is Yes, an additional question (13B) asks “How much money will Kyle use from their personal savings to pay for college?” (numerical input field). If the Yes/No radio button of Question (14A) is Yes, an additional question (14B) asks “How much debt will Kyle have upon entering college?” (numerical input field).

The College Characteristics button 1024F and corresponding display area may include some fit/culture questions and include: (16) “What college size does Kyle prefer?” (checkboxes including the following selections: (i) Small (less than 5,000 students), (ii) Medium (between 5,000 and 15,000 students), (iii) Large (more than 15,000 students and (iv) No preference/I don't know), (17) “How important is college size to Kyle?” (Importance Radio buttons, which include five options: very important, kind of important, pretty indifferent, not important at all and No preference/I don't know), (18) “What campus setting does Kyle prefer?” (Checkboxes with the following options: (i) Rural (country, near farms, wilderness, small towns), (ii) Town (small towns, relatively near large cities), (iii) Suburban (small cities, large towns, near large cities), (iv) Urban (in cities) and (v) No preference/I don't know), (19) “How important is campus setting to Kyle?” (Importance Radio buttons), (20) “How close to home does Kyle want college to be?” (Checkboxes with the following options: very close (within 1 hour drive), close (1-3 hour drive), can get home for the weekend (3-5 hour drive), not close (5-8 hour drive), get me out of here (over 8 hour drive) and no preference/I don't know), (21) “How important is proximity to home for Kyle?” (Importance Radio buttons), (22) “What geographic region does Kyle prefer?” (Checkboxes with the following options: New England (CT, ME, MA, NH, RI, VT), Mid-East (DE, DC, MD, NJ, NY, PA), Great Lakes (IL, IN, MI, OH, WI), Plains (IA, KS, MN, MO, NE, ND, SD), Southeast (AL, AR, FL, GA, KY, LA, MS, NC, SC, TN, VA, WV), Southwest (AZ, NM, OK, TX), Rocky Mountains (CO, ID, MT, UT, WY), Far West (AK, CA, HI, NV, OR, WA), Outlying Areas (AS, FM, GU, MH, MP, PR, PW, VI) and No preference/I don't know), (23) “Are there any states that should be excluded from your search?” (checkboxes of the listing of states based on the answer to Question (22), for example, when mid-east is checked, the input checkboxes for Question (23) is Delaware, District of Columbia, Maryland, New Jersey, New York and Pennsylvania).

The College Characteristics button 1024F and corresponding display area may include additional fit/culture questions including: (24) “How important is geographic region to Kyle?” (Importance Radio buttons), (25) “How important is Greek life for Kyle?” (Importance Radio buttons), (26) “How important is the availability of on-campus, extra-curricular activities for Kyle?” (Importance Radio buttons), (27) “How important is racial diversity to Kyle?” (Importance Radio buttons), (28) “How important is attending a college with a ‘sports culture’ for Kyle?” (Importance Radio buttons), (29) “How important is attending a college with a religious affiliation for Kyle?” (Importance Radio buttons), (30) “Which religious affiliation does Kyle prefer?” (Radio buttons including, for example, Christian, Jewish, Unitarian, Mormon, Muslim, No affiliation preference), (31) “Does Kyle only want to attend a college with a [insert answer to Question (30)] affiliation?” (Yes/No radio button), and (32) “How important are these college ‘fit’ questions to relative to Kyle's purely financial considerations?” (Radio buttons with the following options: (i) College fit is way more important than financial considerations, (ii) College fit matters more, but finances matter, too, (iii) College fit and finances matter equally, (iv) Finances matter more, but college fit matters, too, (v) Just give me the best financial deal, period, and (vi) No preference/I don't know).

The Career goals and major button 1024G and corresponding display area may include: (33) “What type of major is Kyle interested in?” (Radio buttons including most popular majors, for example, each radio button may correspond to one of: Architecture, Agriculture and Vet Sciences, Biology and Biomedical Science, Business, Communications, Computer and Information Sciences, Education, Engineering, Family and Consumer Sciences, Health and Medicine, Humanities, Mathematics, Mult-Disciplinary Studies, Psychology, Public and Social Services, Science, Social Sciences, Visual and Performing Arts and Technologies/Technicians or the like) and (34) “What major from the [insert type from Question (33)] is Kyle interested in?” (Radio buttons corresponding to the different categories for the specific type of major selected; for example, when Business is chosen for Question (33), the Radio Buttons for Question (34) include Accounting, Business Admin, Business Economics, General Business, Construction Management, Entrepreneurship, Finance, Hospitality Admin/Management, Human Resources Management, International Business, Management Sciences, Marketing, Real Estate and Sales).

The Career goals and major button 1024G and corresponding display area may also include: (35) “What kind of future lifestyle does Kyle want?” (Radio buttons including: Prioritize work first, particularly early in career, work/life balance is important, maxes out working 40 hours per week, wants a job the permits taking off and having vacations), (36) “How important is education quality relative to purely financial considerations?” (Important Radio buttons).

The Financial Future button 1024H and corresponding display area may include: (37) What “return on investment” percent do you require for Kyle's college education per year?” (numerical percentage input field), (38) “What amount of total student loans (if any) will you tolerate borrowing for college?” (numerical input field), (39) “How many hours per week will Kyle likely work during the summer?” (numerical input field), (40) “How many dollars per hour will Kyle likely make from summer job?” (numerical input field), (41) “How many weeks will Kyle likely work during summer breaks?” (numerical input field), (42) “What percent of your income from work during summer breaks do you want applied to tuition?” (percentage input field), (43) “How many hours per week will Kyle likely work during school year?” (numerical input field), (44) “How many dollars per hour will Kyle likely make from job during school year?” (numerical input field), (45) “How many weeks will Kyle likely work during the school year?” (numerical input field), (46) “What percent of your income from work during the school year do you want applied to tuition?” (percentage input field) and (47) using your best guess, what will be the likely amount of Kyle's monthly living costs after graduation? (not including student loans)” (dollar amount input field).

The answer to Question (38) may correspond to the debt ceiling and the Questions (39)-(46) and corresponding input fields may correspond to the work calculator questions/inputs.

### Scoring, Ranking and Grading

As discussed above, schools may be displayed (e.g., Top Colleges) based on an overview (or personalized) ranking, an academic ranking, a financial ranking and a fit (or culture) ranking. The highest score corresponds to the highest ranking and/or grades may be assigned based on ranges of scores (e.g., A equals 95th percentile and above, etc.).

### 1. Personalized (Overview) Ranking.

The personalized (or overview) score may be an aggregate scoring based on the final scores of each of the following three (3) categories: Finance, Fit (Culture), and Academic. Personalized (Overview) Ranking is an aggregate score across all three categories.

In addition, the survey includes questions that permit students to weight each category (e.g. Finance more important than Fit), which may also influence the personalized ranking score. Thus, the personalized scoring may be weighted based on what the user identifies as most important.

### 2. Admissions Probability Scoring.

In essence, the prospective student's standardized test scores (e.g., SAT/ACT scores) are compared to the colleges' standardized test scores (e.g., SAT/ACT scores), and then admission probability is measured based upon the variance. According to an embodiment, the following three step process for admission probability scoring may be used:

Step #1: (Student's SAT and/or ACT score minus the college's SAT and/or ACT midpoint score) divided by the Student's SAT and/or ACT Score. This calculation may be performed for each of the three SAT categories (reading, writing, and math). ACT score information may be used when SAT information is unavailable. Effectively, this calculation reflects the percentage (likelihood, probability) that a student's SAT and/or ACT score is higher or lower than the college's SAT/ACT midpoint.

Step #2: All of the percentages from all three categories calculated under Step 1 are added together. For example, when a student's Reading Score exceeds the school's midpoint by 10%, a Math Score exceeds the school's midpoint by 20%, and a Writing Score exceeds the school's midpoint by 15%, the admission probability score would be 45% (10%+20%+15%).

Step #3. The number calculated under Step #2 is divided by three (3). For example, the 45% calculated above would be divided by three (45%/3) to reflect the total probability of admissions (e.g., 15%). Note: if the sum exceeds 99%, 99% is used as a maximum admissions probability.

### 3. Academic Scoring and Grade.

The method(s) discussed above may include: receiving one or more user inputs corresponding to user desired academic quality information; and storing, in the database in association with the user profile, the user desired academic quality information, wherein the database further stores respective educational institution academic quality information in association with each of the plurality of educational institutions, and the calculating, based at least in part on the corresponding financial rating information, the ranking of the educational institutions includes calculating the ranking of the educational institutions based on how closely the user desired academic quality information corresponds to the respective educational institution academic quality information of respective educational institutions of the plurality of educational institutions compared to other educational institutions of the plurality of educational institutions.

The one or more user inputs corresponding to user desired academic quality information may include one or more of: a grade point average, class rank, or a standardized test score.

According to an embodiment, a college's standardized test (e.g., SAT and/or ACT) average scores are converted into an academic score. In doing so, the logic is that the selectivity of a college represents the academic rigor of a college. Of course, other measures of academic rigor (e.g., faculty excellence, research and innovation) may be used besides standardized test scores. According to an embodiment, the academic score may be calculated according to Table 1 below:

TABLE 1
Table 1:

| College SAT Midpoint | Academic Score |
|---|---|
| 1500-1600 | A |
| 1400-1499 | B |
| 1300-1399 | C |
| 1200-1299 | C |
| 1000-1199 | D |
| 800-999 | D |
| 0-799 | F |

### 4. Fit (Culture) Scoring and Grade.

The methods discussed above may include receiving one or more user inputs corresponding to one or more educational institution attributes (characteristics, factors); and storing, in the database in association with the user (or student) profile, the one or more educational institution attributes, and the calculating, the ranking of each of the educational institutions of the subset may include calculating the ranking of each of the educational institutions of the subset based on how closely the one or more user inputs corresponding to the one or more educational institution attributes corresponds to the respective educational institution information of respective educational institutions of the plurality of educational institutions compared to other educational institutions of the plurality of educational institutions. The user input prompts are discussed further below with relation to FIGS. 10A and 10B and the survey questions.

The one or more user inputs related to educational institution attributes (characteristics, factors) may be related to the Fit or Culture scoring. The one or more educational institution attributes may include at least one of: a location, a population density setting (e.g., urban or rural setting), a distance from home, a region, a student enrollment, a religious affiliation, racial diversity, Greek life, extent of extra-curricular activities, or a sports culture.

Fit (or Culture) scoring is based on non-academic and non-financial attributes of the school compared to the user-entered student profile data (e.g., user-entered survey data). According to an embodiment, the fit (culture) calculation may include determining whether the student's expressed fit/cultural preference matches the college's objective characteristic for the same (or substantially related) fit/cultural factor, and (2) when the student's expressed fit/cultural preference matches the college's objective characteristic, the factor is overweighted or underweighted based upon a level of importance as indicated by the user (e.g., in the survey).

According to an embodiment, the factor for a characteristic may correspond to a score provided by an external source (e.g., the school). According to certain embodiments, for certain characteristics (e.g., student body size, racial diversity), a score may be calculated. Tables 2-4 below further explain the process of calculating the factor score for various characteristics, according to various embodiments:

TABLE 2
Table 2:

| Applicable Fit | Step #1: | Step #2: |
|---|---|---|
| Factors | Importance Score | Determine Match |
| Size | The student may indicate the level | If student Fit |
| Setting | of importance of the fit | Factor preference |
| Home proximity | factor/characteristic (e.g., during | matches the |
| Region | the survey). If the school complies | college's |
| | with the student's entry (e.g., | characteristic, |
| | within the threshold proximity to | then assign the |
| | home based on Zip Code), the | Importance Score |
| | scoring may be weighted as | as a weighted |
| | follows: | (weight adjusted) |
| | Very Important = 10 | score for that |
| | Kind of Important = 7 | factor/ |
| | Pretty Indifferent = 2 | characteristic. |
| | Not Important = 0 | |
| | Don't Know = 0 | |
| | If the school does not comply with | |
| | the student's entry (e.g., not | |
| | within the threshold proximity to | |
| | home based on Zip Code), the | |
| | score may be zero (0) or a | |
| | negative number (e.g., non- | |
| | compliance plus important could | |
| | be −5 or −10). | |

TABLE 3
Table 3:

| Applicable | Step #1: | Step #2: | Step #3: |
|---|---|---|---|
| Fit | Determine College | Importance | Calculate |
| Factor | Score | score | Factor Score |
| Greek Life | As an example, | The student may | Weighted |
| Extra- | college student body | indicate the level | (weight |
| curriculars | SIZE (enrollment) | of importance | adjusted) |
| Sports | may be used as a | during the survey. | Factor |
| Culture | proxy for Greek Life, | According to an | Score equals |
| | extra-curriculars and | embodiment, the | ((Factor Score |
| | sports culture scored | scoring may be | of [Step #1] |
| | based on a score range | as follows: | multiplied by |
| | from 1-10, which | Very | Importance |
| | may be calculated as | Important = 10 | Score of |
| | follows: | Kind of | [Step #2]) |
| | If student size >30k, | Important = 7 | divided by |
| | Factor Score = 10 | Pretty | 100) |
| | If student size >20k, | Indifferent = 2 | |
| | Factor Score = 8 | Not | |
| | If student size >10k, | Important = 0 | |
| | Factor Score = 6 | Don't | |
| | If student size <10k, | Know = 0 | |
| | Factor Score = 0 | | |

TABLE 4
Table 4:

| Applicable | Step #1: | Step #2: | Step #3: |
|---|---|---|---|
| Fit | Determine College | Importance | Calculate |
| Factor | Score | score | Factor Score |
| A | Step #1 may be the | The student may | Weighted |
| Communities | same as the | indicate the level | (weight |
| or Resource | determining college | of importance | adjusted) |
| Group Factor | score for Greek Life | during the survey. | Factor Score |
| (e.g., | discussed above. | According to an | equals ((Factor |
| organizations | Alternatively, if a | embodiment, the | Score of |
| that share | count of a number of | scoring may be | [Step #1] |
| a common | resource groups is | as follows: | multiplied by |
| identity, | available, a different | Very | Importance |
| interest, | scoring methodology | Important = 10 | Score of |
| background | may be used. For | Kind of | [Step #2]) |
| or goal) | example, each of the | Important = 7 | divided by 100) |
| | below numbers | Pretty | |
| | correspond to a | Indifferent = 2 | |
| | number of resources in | Not | |
| | a population of a | Important = 0 | |
| | college: | Don't | |
| | 0-2: 0 | Know = 0 | |
| | 3-5: 3 | | |
| | 6-10: 5 | | |
| | 11-20: 7 | | |
| | 21+: 10 | | |
| | In other words, the | | |
| | higher the resource | | |
| | groups/organizations | | |
| | at a college, the higher | | |
| | the resource groups | | |
| | factor score. | | |

As shown in Tables 3 and 4 above, some factors require determining a customized college fit/culture score (e.g. racial diversity), rather than simply relying on a score already provided by each college.

### Financial Rankings.

The financial rankings may be based on a multi-step process including: (i) determining college cost, (ii) determining the college earnings, (iii) financial filters, and (iv) calculating the financial score.

### I. Determining College Cost

As part of the calculation, the college's actual cost to the student may be determined, which may be calculated as follows:

Step 1. Calculate the gross cost of college. This means determining the total cost of college per year and multiplying by the number of years a student intends to enroll in college. The gross cost of college may include tuition expenses, room and board, books, and personal expenses.

Step 2. Next, all scholarships applicable to each college are subtracted from the gross cost of college to determine the “net college cost.” For example, if a student has a $30,000 scholarship to Penn State, and Penn State's gross cost equals $100,000, Penn State's “net college cost” equals $70,000.

Step 3. All third-party payments (e.g. parent money) are subtracted from the net college cost.

Step 4. All work/employment wages that occur or are projected to occur in college are subtracted from the number calculated under Step #3 (e.g., the net college cost after Step #3).

Step 5. All private scholarships that are applicable to any college are subtracted from the number calculated under Step #4 (e.g., the net college cost after Step #4).

Step 6. All personal savings and investments that the student personally applies to college costs are subtracted from the number calculated under Step #5 (e.g., the net college cost after Step #5).

After completing this six-step “college cost determination” process, the “unfunded college balance,” which represents the amount of money that remains payable by the student, is determined. The “unfunded college cost” may be referred to as the remaining balance. Often, the unfunded college balance is paid through student loans or other financial aid, although other suggestions may be suggested (e.g., financial reduction strategies) that do not require debt to pay for these amounts.

To the extent that the “unfunded college balance” is negative—meaning that student actually has a surplus of money—these amounts may be considered as cash available to the student. These monies are identified as “cash at graduation.”

### II. Determining the College Earnings

Next, the financial benefit that the student receives by attending a particular college may be determined.

Step 1. First, the Mid-Career Salary may be determined/calculated by multiplying the first-year salary (information often publicly available and also available on private databases) by a projected annual salary increase (e.g. 4% annualized) by the number of years representing the time between graduation and the student's mid-career (e.g. 10 years, 20 years). In other words, the computer processing may assume that a college graduate receives a 4% raise each year for ten-years, which represents their mid-career salary. There may be other ways to calculate mid-career salary, such as using other databases.

Step 2. The mid-career salary (Step #1) is then multiplied by the average working years after graduation (e.g., as determined by whether male or female).

Step 3. The number calculated under Step #2 (e.g., the mid-career salary) may be divided by (1—the unemployment rate for students graduating from the particular college). This number is the projected mid-career salary, adjusted for unemployment, which may be considered to be a student's projected “lifetime earnings.”

Step 4. The number calculated under Step #3 (e.g., projected mid-career salary) may be subtracted by the average lifetime earnings made by a high-school graduate (non-college graduate) (e.g., over the same time span). This equals the “gross college premium,” or the amount of gross money a student earns more than a high-school graduate by virtue of graduating from a particular college.

Step 5. The gross college premium may be adjusted for taxes by multiplying the gross college premium by the average tax rate (percentage) to generate the “tax adjusted college premium.” The tax rate may be based on federal, state and/or local tax rates and/or projected tax rates.

Step 6. The “tax-adjusted college premium” calculated under Step #5 may be subjected to a present value calculation, which final number may be referred to as the “adjusted college premium.”

### III. Financial Filters

Three (3) or more financial filters for excluding recommended colleges may be used, which may be derived from user input as follows:

1. Return on Investment Minimum. All colleges that fail to satisfy the minimum return on investment (a number provided by the user) are excluded.

2. Student Loan Maximum. All colleges that maintain an “unfunded college balance” in excess of the maximum amount of student loans (a number provided by the user, such as via the survey) are excluded.

3. Monthly Affordability Minimum. All colleges where the student's projected one-year salary is less than the user's projected monthly expense after graduation (a number provided by the user or otherwise calculated as part of the user's input, such as via the survey) are excluded.

### IV. Calculating the Financial Score

Next, all colleges that pass through the financial filters calculated under Section 3 are analyzed by using numbers calculated under Section 1 and Section 2 (e.g., by using the determine college cost and the determined college earnings). A “Numerator” (described in Table 5 below) is calculated. The Numerator may represent the present value of all cash flows generated from going to college (i.e. adjusted college premium and cash at graduation), less the costs to the student from going to college (i.e. unfunded college balance, opportunity cost going to college).

The “Numerator” may then be divided by the “Denominator” (described in Table 6 below), which may generally represent the present value of all cash flows generated from going to college (i.e. adjusted college premium and cash at graduation).

TABLE 5
Table 5:
Numerator

| | | |
|---|---|---|
| “Adjusted College Premium” | plus | Any “cash at graduation” as |
| as calculated under Section 2, | | calculated under Section 1. |
| Step #6 | | |

Divided By

| | | |
|---|---|---|
| 1 plus the discount rate used | Less | The “unfunded college balance” |
| in the present value | | as calculated under Section 1, |
| calculation under Section | | Step #6 plus |
| Taken to the exponent of | | the “opportunity cost” of going |
| The average working years | | to college (i.e. the average salary |
| after college graduation | | earned by a high-school graduate |
| | | multiplied by the number of |
| | | years a student is in college) |
| | | less Money from student work/ |
| | | employment applied to tuition |
| | | (as indicated by the user) |

TABLE 6
Table 6:
Denominator

| | | |
|---|---|---|
| “Adjusted College Premium” | plus | Any “cash at graduation” as |
| as calculated under Section 2, | | calculated under Section 1. |
| Step #6 | | |

Divided By
1 plus the discount rate used in the present value
calculation under Section
Taken to the exponent of
The average working years after college graduation

By diving the Numerator by the Denominator, the financial score may be obtained. The financial score may then be scaled (or normalized) from 10 to 100 (with the idea of using ten as a floor so as to not score any qualifying college close to a zero).

A financial letter grade may then be assigned based on the financial score as shown in Table 7 below:

TABLE 7

| Financial Score | Financial Grade |
|---|---|
| 75-100 | A+ |
| 70-74 | A |
| 65-69 | A− |
| 60-64 | B+ |
| 55-59 | B |
| 50-54 | B− |
| 45-49 | C+ |
| 10-45 | C |

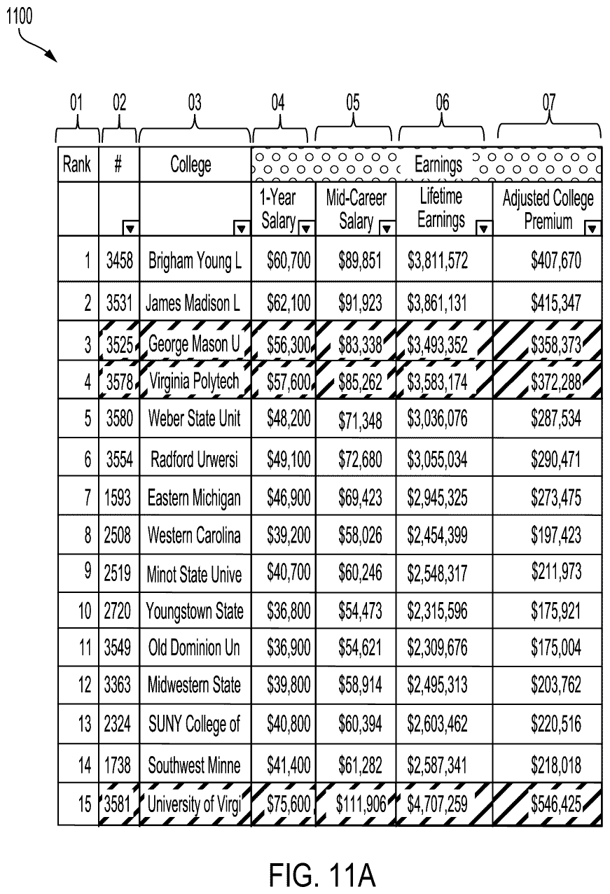

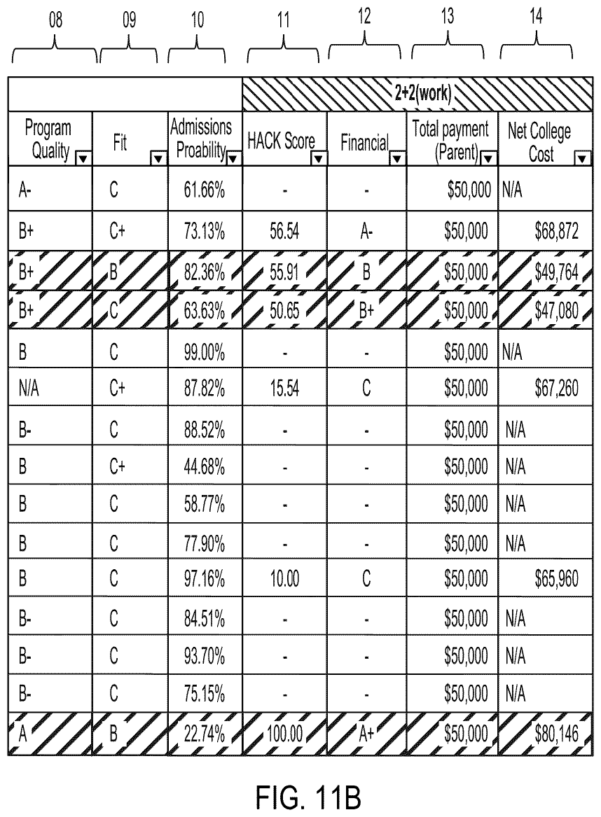

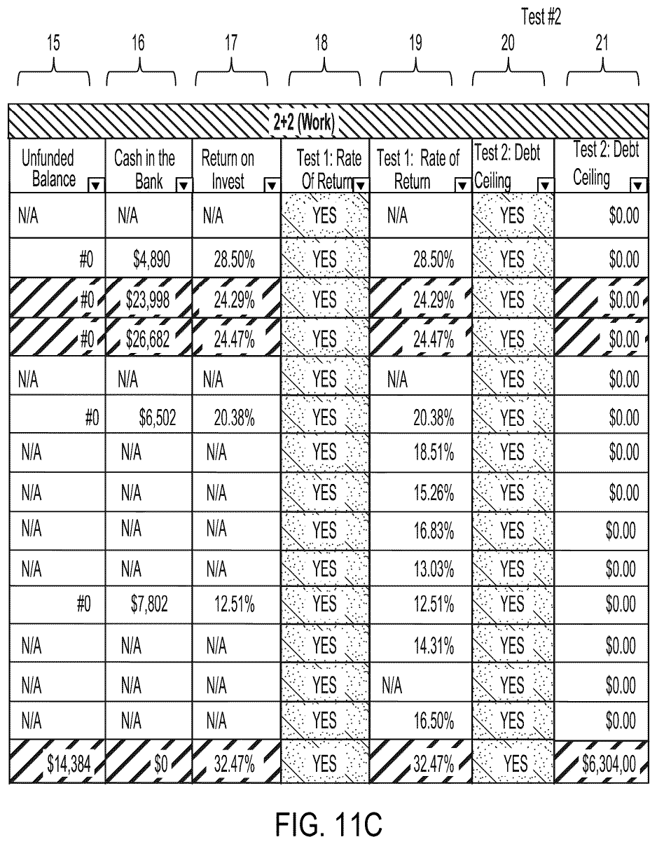

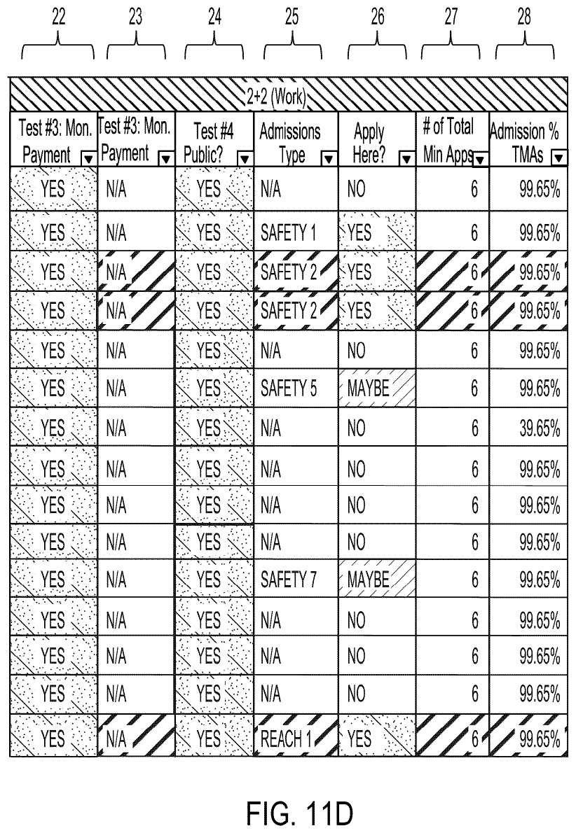

FIGS. 11A-11D show an example of a data table (or data set instance) 1100 of the database which stores the information shown in FIGS. 11A-11D and aggregates school data together, according to an embodiment. Each row may correspond to a college/school. The school data columns may include an overall rank 01, a unique identifier number 02, a college name 03, a 1-year salary 04, a mid-career salary 05, a projected lifetime earnings 06, an adjusted college premium 07, a program quality grade 08, a college fit grade 09, an admissions probability percentage 10, a HACK score 11 (which may be short hand for an aggregate score, an overall score or an overview score, and which may correspond to all the categories), a financial score 12, a total payments (from parent) amount 13, a net college cost 14, an unfunded college cost amount 15, a cash in bank amount 16, a return on investment percentage 17, a rate of return test (Pass) Boolean 18, a rate of return (if no) percentage 19, a below threshold (debt ceiling) test Boolean 20, a below threshold (debt ceiling) amount 21, a monthly payment(s) test Boolean 22, a monthly payment(s) amount 23, a public school Boolean 24, an admissions type 25, an apply here (recommendation indicator) 26, a number of total minimum applications 27, and an admission percentage with minimum applications percentage 28.

The overall rank 01 corresponds to the personalized (or overview/overall) ranking is the same as the overview/overall ranking, which may rank each of the school's based on the HACK Score 11, which is a personalized (overview/overall) score.

The 1-year salary 04 and mid-career salary 05 may be based on school data (e.g., sourced from the Department of Education or another external server). The projected lifetime earnings 06 may be calculated as discussed above (e.g., based on the number of projected average working years multiplied by the projected mid-career salary, which may be adjusted for unemployment).

An adjusted college premium 07 may be calculated as discussed above (e.g., based on the present value of (the lifetime earnings minus the average lifetime earnings made by a high-school graduate, which may be adjusted for taxes)).

A program quality (or academic quality) grade 08 may be calculated based on the academic quality calculations and scoring discussed above.

A college fit grade 09 may correspond to a grade based on the weighted factor score (although, according to an embodiment, the weighted factor score, unadjusted/unweighted factor score and importance factors may also be stored in the database, which means the college fit grade 09 may include multiple columns).

An admissions probability percentage 10 may be calculated based on the admissions probability calculations discussed above. A HACK score 11 may correspond to the overall score (e.g., based on three categories) and be calculated based on a multi-step process. The multi-step process may include calculating a raw score and calculating a scaled (or normalized) score. The rankings may be based on the scaled score.

### I. Calculate Raw Score

Step #1: Determine the weightings of each of the three (3) categories on a percentage basis. The user can drive the computer to adjust these default weightings based on survey responses.

Step #2. Multiply the final academic score by the academic weight percentage.

Step #3. Multiply the final finance score by the finance weight percentage.

Step #4. Multiply the final fit score by the fit weight percentage.

Step #5. Add the numbers calculated under Step #2, Step #3, and Step #4.

This represents the aggregate weighted college score across all three (3) categories (fit, finance, academic).

### II. Calculate Scaled Score

The aggregate weighted college score (i.e., the final number calculated under Section 1) is scaled from 10 to 100 (with the idea of using ten as a floor so as to not score any qualifying college close to a zero). This represents the aggregate weighted college (scaled) score across all three (3) categories (fit, finance, academic). We commonly refer to this score as the “HACK score.”

### III. Rank Scaled Score

Each college may be assigned a number/rank, which represents the overall personalized college rank, with the #1 college having the highest HACK score. A personalized college rank may be assigned to all eligible colleges that are not otherwise filtered out by user responses.

A financial grade 12 may be stored here and may be a letter grade based on the financial grade (based on the financial scoring) discussed above. See also Table 7.

A total payments (from parent) amount 13 may be calculated based on user input from survey or calculator GUI.

A net college cost 14 may be stored here and be calculated as discussed above. The net college cost may correspond to a cost of attendance and may be derived from (or calculated based on) the Gross Cost of College (tuition, room and board, books) minus all scholarships/grants awarded by the particular college.

An unfunded college cost amount 15 may correspond to a remaining balance and be calculated as discussed above. As an example, the unfunded college cost amount may correspond to the Gross Cost of College (e.g., tuition, room and board, books) minus all scholarships/grants awarded by the particular college minus all third-party payments (e.g., from family, parents), minus all work/employment monies applied to college expenses, minus all private scholarships/grants applicable to any college, minus all personal savings/investments that student applies from own accounts. A cash in bank amount 16 may be based in part on user-entered student survey data. The cash in bank amount 16 may be based on a cash in bank amount calculated based on financial calculations discussed herein.

A return on investment percentage 17 may be stored here and correspond to a return on investment calculation discussed above. According to an embodiment, the return on investment percentage may correspond to “adjusted college premium” divided by (gross college cost plus the “opportunity cost” of going to college (i.e. average salary earned by a high-school graduate multiplied by number of years student is in college, less wages student actually earns in college). Then take this number to one over an exponent that represents the number of years for an investment period, such as a 20-year investment period (e.g. \hat{ }1/20), which represents a return period over a 20-year period.

A rate of return test (Pass) Boolean 18 may be used to indicate whether a college ROI is less than a user provided ROI minimum threshold. When a college ROI is less than a user provided ROI minimum threshold (e.g., rate of return test Boolean 18 is NO), the college is excluded.

When college ROI is more than user provided ROI minimum (e.g., rate of return test Boolean 18 is YES), the college is not excluded based on this test (e.g., included and analyzed).

A rate of return percentage 19 may include a percentage that corresponds to a rate of return.

A below threshold (debt ceiling) test Boolean 20 may be a YES/NO (TRUE/FALSE) value indicating whether the amount needed to borrow is above the student entered data.

A below threshold (debt ceiling) amount 21 may indicate how much below the debt ceiling the cost of attendance is after accounting for the other contributions (e.g., parent money, working, scholarships).

A monthly payment(s) test Boolean 22 may be a Boolean (YES/NO) used to indicate whether an unfunded college balance is more than a student loan max threshold. When the unfunded college balance is more than student loan max threshold (e.g., monthly payment test Boolean 22 is NO), the college is excluded. When the unfunded college balance is less than (or equal to) the student loan max threshold (e.g., monthly payment test Boolean 22 is YES), the college is not excluded on this basis (e.g., included and analyzed).

A monthly payment(s) amount 23 may correspond to how much the student is willing to pay per month to contribute to the education. A public school Boolean 24 indicates YES if the school is a public university and NO otherwise.

An admissions type 25 may indicate the admissions category discussed above. An apply here (recommendation indicator) 26 may indicate a YES if the school is a recommended school, and a NO if the school is not a recommended school. A number of total minimum applications 27 may indicate the total number of applications the student will most likely gain admission into the college applied to. According to an embodiment, a minimum of 9 colleges may be recommended to be applied to. To the extent less than 9 colleges are recommended, all recommended colleges may be recommended to be applied to. To the extent more than 9 colleges are recommended, the top 3 colleges in each admission category (match, safety, reach) are recommended to be applied to.

An admission percentage with minimum applications percentage 28 indicates a percentage probability that the student will be accepted by at least one of the colleges to which the system recommends the student apply.

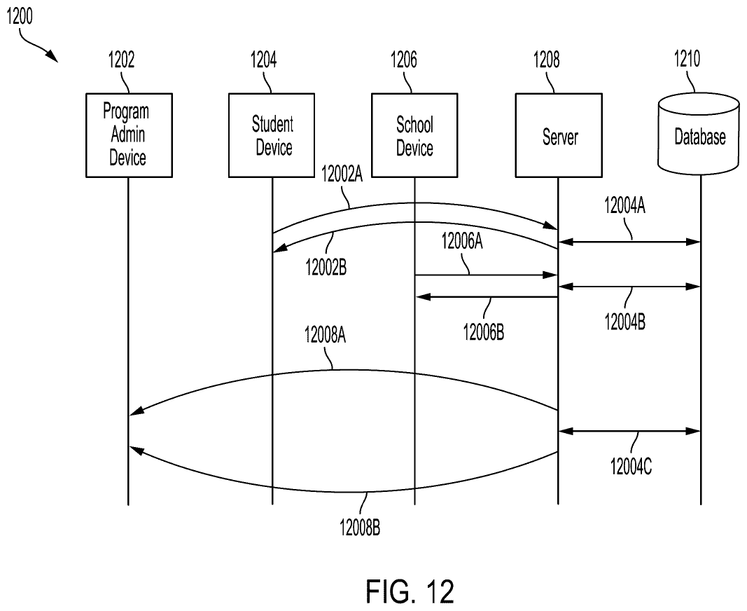

FIG. 12 illustrates a diagram of network requests, according to certain embodiments. The network request(s) may include the network transmissions as described above. Specifically, the communications between the responsive server and the various electronic devices may include network communications as shown in FIG. 12. For example, Operation 1202A may include a user (e.g., student) requesting a webpage (i.e., the student electronic device 1204 sending a webpage request (e.g., by clicking a button or hyperlink) to the sever 1208 over the network), and, in response to receiving that request, the server 1208 may perform communication with the database 1210, and transmit the web page information (or GUI application control information) to the student device 1204 to cause the student device 1204 to display the student GUI application. In a similar respect, the program administrator device 12021 may request a webpage from the server 1208 (Operation 1208A), which causes the server 1208 (Operation 1200C) to communicate with the database, and transmit the webpage information (or GUI application control information) to the program administrator device 1202 to cause the program administrator device to provide a display application that includes program administrator GUIs. The Program Admin Device 902 may request a webpage or to log in to an application, which causes the server 1208 to communicate with the database 1210, and provide the program administrator GUI experience to the Program Admin Device 1202 for maintenance and updating the programs described herein.

The database communication may include the server reading/writing from/to the database in response to request and/or updates (e.g., the apply/save changes buttons discussed above). The database may also have scheduled tasks that are run by the server on the database.

Each of the operations of FIG. 9 may be performed in various different orders and/or simultaneously and continuously to provide real time updates. The network requests may include multiple requests/responses and the communications may include more than repetitive GUI requests (e.g., the computing devices may transfer information back and forth to the server, which uses the database as storage, including multiple real time database transactions). According to an embodiment, time is a variable on the vertical, but the network requests/responses may be performed repeatedly and in differing temporal orders.

According to an embodiment, each of the users may have the same types of network patterns. The database may be local to the server or be external to the server (e.g., a third-party server cloud platform). The network requests may be direct or indirect requests (e.g., requests that travel through another server system, such as a web host server system).

The server 1208 may also interact with a school device (e.g., a school server, a U.S. Department of Education server, a third-party private server) to obtain school information (in Operations 1206A, 1206B) and this information may be saved in the database (Operations 1204B).

Overlapping elements are not repeated and may correspond to previously described elements having a same or similar name (e.g., a new instance of a GUI button may correspond to the previous description of the same button). While explaining the drawings according to embodiments of the disclosure, a detailed description of the contents overlapping with the drawings according to the embodiments is omitted.

Although exemplary embodiments have been shown and described, the disclosure is not limited thereto, and various modifications and variations are possible within the scope of the disclosure. It will be appreciated by those skilled in the art that changes may be made in these exemplary embodiments without departing from the principles and spirit of the general inventive concept, the scope of which is defined in the appended claims and their equivalents.

What is claimed is:

1. A real time server system method performed by a hardware server system, the real time server system method comprising:
providing access to a database stored in a memory, wherein the database stores student profile information and school information, wherein the student profile information includes an associated threshold budget and personalized school ranking information, and the school information includes, of each respective educational institution of a plurality of educational institutions, financial rating information and an expected financial cost of attendance;
accessing the database to obtain the personalized school ranking information;
generating first recommendation list information that includes a first list of recommended educational institutions in a ranked order based on the personalized school ranking information with a highest ranked educational institution at the top followed below by increasingly lower ranked educational institutions, the generating the first recommendation list information comprising:
excluding, from the first recommendation list information, educational institutions that satisfy at least one user-selectable financial exclusion criterion;
displaying, on a display screen of an electronic computing device, a first user interface displaying the first list of recommended educational institutions in a ranked order based on the personalized school ranking information with a highest ranked educational institution at the top followed below by increasingly lower ranked educational institutions;
displaying, on the display screen of the electronic computing device, a second user interface including two or more interactive elements, the two or more interactive elements including a first interactive element corresponding to a first financial reduction strategy and a second interactive element corresponding to a second financial reduction strategy;
in response to the user selecting the first interactive element, calculating a first value corresponding to the first financial reduction strategy, and updating the threshold budget in the database based on the first value;
in response to the user selecting the second interactive element, calculating a second value corresponding to the second financial reduction strategy, and updating the threshold budget in the database based on the second value;
determining, with respect to each of the plurality of educational institutions, whether the respective financial cost of attendance is equal to or below the updated threshold budget;
identifying a subset of the plurality of educational institutions that includes, from among the plurality of educational institutions, those educational institutions having a respective expected financial cost of attendance that is equal to or below the updated threshold budget;
calculating, based at least in part on the financial rating information, a ranking of each of the educational institutions of the subset;
generating second recommendation list information that includes a unique personalized second list of recommended educational institutions in a ranked order based on the calculated ranking of each of the educational institutions of the subset with a highest ranked educational institution at the top followed below by increasingly lower ranked educational institutions, wherein the second recommendation list information includes more educational institutions than the first recommendation list information, the generating the second recommendation list information comprising:
excluding, from the second recommendation list information, educational institutions that satisfy the at least one user-selectable financial exclusion criterion;
storing the second recommendation list information in the memory; and
displaying, on the display screen of the electronic computing device, a third user interface including the second list of recommended educational institutions in a ranked order based on the personalized school ranking information with a highest ranked educational institution at the top followed below by increasingly lower ranked educational institutions.

2. The real time server system method of claim 1, further comprising:
before accessing the database to obtain the personalized school ranking information:
extracting, from an external government server or website or a private server or website, the respective expected school financial cost of attendance information of each of the plurality of educational institutions; and
storing, in the database, the extracted expected school financial cost of attendance information.

3. The real time server system method of claim 1, further comprising:
prior to accessing the database:
receiving user input corresponding to at least a part of the associated threshold budget; and
storing the user input corresponding to the associated threshold budget in the database in association with the student profile information.

4. The real time server system method of claim 1, further comprising:
accessing, from the database, salary information corresponding to an expected first-year salary of a specified degree offered by one or more educational institutions of the plurality of educational institutions;
calculating, based on the expected first-year salary of the specified degree over a projected career lifetime, an expected lifetime earnings corresponding to the specified degree;
calculating an expected return on investment (ROI) on the specified degree of each of the plurality of educational institutions that offer the specified degree, based on the expected lifetime earnings corresponding to the specified degree and the financial cost of attendance information; and
determining the financial rating information of each of the plurality of educational institutions based on the calculated expected ROI.

5. The real time server system method of claim 4, further comprising:
prior to accessing the database:
receiving user input corresponding to a designation of the specified degree; and
storing an indication of the specified degree in the database in association with the student profile.

6. The real time server system method of claim 4, wherein the salary information is based on expected first-year salary information extracted from at least one of a government server, a private server or a website, the expected first-year salary information corresponding to an expected salary of an entry level graduate having the specified degree.

7. The real time server system method of claim 4, wherein the calculating the expected lifetime earnings corresponding to the specified degree includes projecting earnings over a career based on the expected salary of the specified degree and a salary increase during the career, wherein the career corresponds to a projected number of years of a career of a person corresponding to the student profile.

8. The real time server system method of claim 4, wherein the calculating the expected ROI includes one of:
(A) calculating how much more the expected lifetime earnings corresponding to a graduate having the specified degree is compared to an expected lifetime earnings of a person who does not attend college; or
(B) subtracting the expected financial cost of attendance from the expected lifetime earnings.

9. The real time server system method of claim 1, further comprising:
prior to accessing the database:
receiving one or more user inputs corresponding to an expected contribution to the threshold budget;
calculating a total expected contribution to the threshold budget based on the received one or more user inputs corresponding to the expected contribution;
adjusting the threshold budget based on the total expected contribution to the threshold budget; and
storing the adjusted threshold budget in the database.

10. The real time server system method of claim 1, wherein the response to determining the user has selected the first interactive element or the second interactive element includes displaying the calculated first value or calculated second value corresponding to the selected interactive element after calculating the first value or the second value corresponding to the selected interactive element.

11. The real time server system method of claim 1, wherein the response to determining the user has selected the first interactive element or the second interactive element includes displaying, in a pop-up window or a different user interface, a calculator user interface configured to receive a user input corresponding to a user-entered value, and the calculated value corresponding to the selected interactive element corresponds to the user-entered value.

12. The real time server system method of claim 9, further comprising:
calculating a remaining balance of at least one educational institution of the subset by subtracting the total expected contribution to the threshold budget from the respective financial cost of attendance of each educational institution of the subset;
storing the remaining balance of the at least one educational institution of the subset in the database in association with the student profile; and
displaying, on the display screen of the electronic computing device, the third user interface including displaying, adjacent to the respective educational institution, the calculated remaining balance of the at least one educational institution of the subset.

13. The real time server system method of claim 1, further comprising:
receiving one or more user inputs corresponding to one or more educational institution attributes; and
storing, in the database in association with the student profile, the one or more educational institution attributes, wherein
the calculating, based at least in part on the corresponding financial rating information, the ranking of each of the educational institutions of the subset includes calculating the ranking of each of the educational institutions of the subset based on how closely the one or more user inputs corresponding to the one or more educational institution attributes corresponds to the respective educational institution information of respective educational institutions of the plurality of educational institutions compared to other educational institutions of the plurality of educational institutions.

14. The real time server system method of claim 13, wherein the one or more educational institution attributes include at least one of: a location, a population density setting, a distance from home, a region, a student enrollment, a religious affiliation, racial diversity, Greek life, an extra-curricular activity, or a sports culture.

15. The real time server system method of claim 1, further comprising:
receiving one or more user inputs corresponding to user desired academic quality information; and
storing, in the database in association with the student profile, the user desired academic quality information, wherein the database further stores respective educational institution academic quality information in association with each of the plurality of educational institutions, and the calculating, based at least in part on the corresponding financial rating information, the ranking of the educational institutions includes calculating the ranking of the educational institutions based on how closely the user desired academic quality information corresponds to the respective educational institution academic quality information of respective educational institutions of the plurality of educational institutions compared to other educational institutions of the plurality of educational institutions.

16. The real time server system method of claim 15, wherein the one or more user inputs corresponding to user desired academic quality information includes one or more of: a grade point average or a standardized test score.

17. The real time server system method of claim 1, wherein the different selectable financial reduction strategy buttons include two or more of the following strategies: a work in college strategy, attending community college strategy, an accelerated graduation timeline strategy, a scholarship strategy, a pre-college credits strategy, a college money saving activities strategy, a college money generating activities strategy, an out-of-state college reciprocity strategy, or an attaining in-state residency strategy.

18. The real time server system method of claim 1, wherein the different selectable financial reduction strategy buttons include two or more of the following strategies: a work in college strategy, a work-study program strategy, a paid internship strategy, a paid externship strategy, a residential assistant strategy, a federal scholarship strategy, a state scholarship strategy, a private grant strategy, an Advanced Placement credit strategy, a College Level Examination Program strategy, an International Baccalaureate strategy, a dual enrollment strategy, a summer classes strategy, a military program strategy, a Reserve Officers' Training Corps (ROTC) strategy, a living at home strategy, a reducing room and board expense strategy, an attending community college strategy, an accelerated graduation strategy, a scholarship strategy, a pre-college credits strategy, a college money generating activities strategy, an out-of-state college reciprocity strategy, or an attaining in-state residency strategy.

19. The real time server system method of claim 1, wherein generating the first recommendation list information further comprises:
excluding, from the first recommendation list information, an educational institution that is specified by user input as an excluded educational institution.

20. A non-transitory computer-readable medium comprising computer-executable instructions that, when executed by processing circuitry, cause the processing circuitry to perform the following operations:
providing access to a database stored in a memory, wherein the database stores student profile information and school information, wherein the student profile information includes an associated threshold budget and personalized school ranking information, and the school information includes, of each respective educational institution of a plurality of educational institutions, financial rating information and an expected financial cost of attendance;
accessing the database to obtain the personalized school ranking information;
generating first recommendation list information that includes a first list of recommended educational institutions in a ranked order based on the personalized school ranking information with a highest ranked educational institution at the top followed below by increasingly lower ranked educational institutions, the generating the first recommendation list information comprising:
excluding, from the first recommendation list information, educational institutions that satisfy at least one user-selectable financial exclusion criterion;
displaying, on a display screen of an electronic computing device, a first user interface displaying the first list of recommended educational institutions in a ranked order based on the personalized school ranking information with a highest ranked educational institution at the top followed below by increasingly lower ranked educational institutions;
displaying, on the display screen of the electronic computing device, a second user interface including two or more interactive elements, the two or more interactive elements including a first interactive element corresponding to a first financial reduction strategy and a second interactive element corresponding to a second financial reduction strategy;
in response to the user selecting the first interactive element, calculating a first value corresponding to the first financial reduction strategy, and updating the threshold budget in the database based on the first value;
in response to the user selecting the second interactive element, calculating a second value corresponding to the second financial reduction strategy, and updating the threshold budget in the database based on the second value;
determining, with respect to each of the plurality of educational institutions, whether the respective financial cost of attendance is equal to or below the updated threshold budget;
identifying a subset of the plurality of educational institutions that includes, from among the plurality of educational institutions, those educational institutions having a respective expected financial cost of attendance that is equal to or below the updated threshold budget;
calculating, based at least in part on the financial rating information, a ranking of each of the educational institutions of the subset;
generating second recommendation list information that includes a unique personalized second list of recommended educational institutions in a ranked order based on the calculated ranking of each of the educational institutions of the subset with a highest ranked educational institution at the top followed below by increasingly lower ranked educational institutions, wherein the second recommendation list information includes more educational institutions than the first recommendation list information, the generating the second recommendation list information comprising:
excluding, from the second recommendation list information, educational institutions that satisfy the at least one user-selectable financial exclusion criterion;
storing the second recommendation list information in the memory; and
displaying, on the display screen of the electronic computing device, a third user interface including the second list of recommended educational institutions in a ranked order based on the personalized school ranking information with a highest ranked educational institution at the top followed below by increasingly lower ranked educational institutions.

21. A responsive server system comprising:
a memory; and
hardware processing circuitry, wherein the hardware processing circuitry is configured to execute computer-executable instructions stored in the memory, which when executed by the processing circuitry, perform the following operations:
providing access to a database stored in a memory, wherein the database stores student profile information and school information, wherein the student profile information includes an associated threshold budget and personalized school ranking information, and the school information includes, of each respective educational institution of a plurality of educational institutions, financial rating information and an expected financial cost of attendance;
accessing the database to obtain the personalized school ranking information;
generating first recommendation list information that includes a first list of recommended educational institutions in a ranked order based on the personalized school ranking information with a highest ranked educational institution at the top followed below by increasingly lower ranked educational institutions, the generating the first recommendation list information comprising:
excluding, from the first recommendation list information, educational institutions that satisfy at least one user-selectable financial exclusion criterion;
displaying, on a display screen of an electronic computing device, a first user interface displaying the first list of recommended educational institutions in a ranked order based on the personalized school ranking information with a highest ranked educational institution at the top followed below by increasingly lower ranked educational institutions;
displaying, on the display screen of the electronic computing device, a second user interface including two or more interactive elements, the two or more interactive elements including a first interactive element corresponding to a first financial reduction strategy and a second interactive element corresponding to a second financial reduction strategy;
in response to the user selecting the first interactive element, calculating a first value corresponding to the first financial reduction strategy, and updating the threshold budget in the database based on the first value;
in response to the user selecting the second interactive element, calculating a second value corresponding to the second financial reduction strategy, and updating the threshold budget in the database based on the second value;
determining, with respect to each of the plurality of educational institutions, whether the respective financial cost of attendance is equal to or below the updated threshold budget;
identifying a subset of the plurality of educational institutions that includes, from among the plurality of educational institutions, those educational institutions having a respective expected financial cost of attendance that is equal to or below the updated threshold budget;
calculating, based at least in part on the financial rating information, a ranking of each of the educational institutions of the subset;
generating second recommendation list information that includes a unique personalized second list of recommended educational institutions in a ranked order based on the calculated ranking of each of the educational institutions of the subset with a highest ranked educational institution at the top followed below by increasingly lower ranked educational institutions, wherein the second recommendation list information includes more educational institutions than the first recommendation list information, the generating the second recommendation list information comprising:
excluding, from the second recommendation list information, educational institutions that satisfy the at least one user-selectable financial exclusion criterion;
storing the second recommendation list information in the memory; and
displaying, on the display screen of the electronic computing device, a third user interface including the second list of recommended educational institutions in a ranked order based on the personalized school ranking information with a highest ranked educational institution at the top followed below by increasingly lower ranked educational institutions.
